(19) United States
(12) Patent Application Publication
(10) Pub. No.: US 2022/0298038 A1
(43) Pub. Date: Sep. 22, 2022

(54) A METHOD FOR DISRUPTING BIOFILMS IN WASTEWATER SYSTEMS

(71) Applicant: GRENOF PTY LTD, Warana (AU)

(72) Inventors: David REDFERN, Warana (AU); Simon BAYLEY, Warana (AU)

(21) Appl. No.: 17/641,552

(22) PCT Filed: Sep. 26, 2020
(86) PCT No.: PCT/AU2020/051029

§ 371 Date: Mar. 9, 2022

(30) Foreign Application Priority Data
Sep. 27, 2019 (AU) 2019903649

(51) Int. Cl. C02F 1/72; C02F 1/66; C02F 1/68

(52) U.S. Cl. CPC C02F 1/722; C02F 1/66; C02F 1/682; C02F 2307/08; C02F 2303/02; C02F 2303/20

(57) ABSTRACT

The invention provides methods for treating or disrupting biofilm in wastewater systems comprising the step of adding to the system at least one biofilm disrupting dose of one or more compounds of general formula I: R—O—O—R¹ I wherein, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H, M⁺, C₁-C₈ alkyl, substituted C₁-C₈ alkyl, aryl, substituted aryl, C₁-C₈ acyl, substituted C₁-C₈ acyl, arylacyl and substituted arylacyl.

### TECHNICAL FIELD

The invention relates to methods for treating or disrupting biofilm in wastewater systems with organic peroxy compounds, in particular, the invention relates to methods for treating or disrupting biofilm with organic peroxy compounds in sewerage networks.

### BACKGROUND OF THE INVENTION

It is to be understood that if any prior art publication is referred to herein, such reference does not constitute an admission that the publication forms a part of the common general knowledge in the art in Australia or any other country.

Wastewater systems, consist of a network of physical structures such as pipelines, wells, sumps, pumping stations, manholes, and channels that convey wastewaters from source (e.g. household, industrial factory including food processing plants, and restaurants), etc to discharge point, (e.g. a wastewater treatment plant (WWTP)). Sewerage systems, for example, are designed to prevent the direct contact of urban populations to unsanitary waste materials and potential microbial pathogens, thus greatly reducing the spread of infectious diseases. Whilst sewerage systems have traditionally been thought of only as hydraulic transport systems for sewage, they also act as reactors where complex physicochemical and microbial processes take place.

Sewerage systems provide an environment that favours the growth of microbial communities. Sewerage systems are rich in organic substrates (e.g. proteins and carbohydrates) containing carbon and hydrogen, and hetero atoms such as oxygen, sulphate and nitrogen, as well as inorganic cations and anions. Hydrolytic and fermentative microbes extract energy from partial degradation of organic substrates with the resulting compounds further catabolised by microbes such as methanogenic archaea and sulphate-reducing microorganisms. Sulphate reducing microorganisms (SRMs) and methanogenic archaea (MA) are groups of microorganisms present in a wide range of environments. Sulphate reducing microorganisms, which include the sulphate reducing bacteria (SRB) and sulphate reducing archaea (SRA), are microorganisms which can perform anaerobic respiration utilizing sulphate (SO₄²⁻) as terminal electron acceptor reducing it to sulphide (H₂S) as the metabolic end-product. Therefore, these sulphidogenic microorganisms “breathe” sulphate rather than molecular oxygen. Sulphate-reducing microorganisms aid in the degradation of organic materials. Most known sulphate reducing bacteria are obligate anaerobes.

Methanogenic archaea, often simply more called methanogens, are anaerobic microorganisms that produce methane as a metabolic by-product of anaerobic respiration. Methane is known to be a highly explosive gas. The lower explosive limit (LEL) of methane is about 4.6±0.3% (volume basis) while the upper explosive limit (UEL) of methane is 15.8±0.4% when methane is ignited in air at 20° C. and 100 kPa (effectively ATP).

Hydrogen sulphide is an inorganic sulphide and is a highly toxic, colourless gas of unpleasant rotten-egg smell. It is responsible for several problems in the environment, such as biogenic corrosion of concrete structures, odour annoyance in urban areas, and toxic risk to sewer workers. During biogenic sulphide corrosion of concrete, a portion of the H₂S is partitioned from the liquid phase (wastewater) into the gas phase headspace in sewer pipes and other locations where there is a headspace. The gaseous H₂S can then partition back into condensation layers on the gas-phase exposed walls of concrete pipe. These surface layers become a habitat for sulphate oxidizing bacteria (SOB). Colonies of these aerobic bacteria metabolize the hydrogen sulphide gas to sulphuric acid. The sulphuric acid produced by microorganisms can interact with the surface of the structure material reacting with alkaline cement materials and producing gypsum and ettringite that have poor structural capacity leading to weakened structure and eventual collapse of the concrete. Other reduced sulphur species are present within wastewater systems. For example, methanethiol (methyl mercaptan) can be generated during the microbial breakdown of sulphur containing macromolecules. In light of what has been outlined above, the presence of certain microbes, including SRM and MA, in sewer networks and other wastewater treatment systems, is a problem due to their capacity to produce hydrogen sulphide, mercaptans and methane under anaerobic conditions.

The management of emissions from sewerage networks is an important issue for sewerage system operators. The treatment of wastewater, such as raw sewage, within the sewerage system is required to ensure that emissions emanating from the sewer are controlled or eliminated and corrosive gases are reduced to protect the concrete sewerage system structures. Chemical methods have been used in an attempt to control sulphide and methane emissions in sewers. Chlorine based oxidizing chemicals such as gaseous chlorine, liquid sodium hypochlorite and chlorine dioxide have been used to control emissions from sewerage systems. Chlorine compounds have been found to react with naturally occurring organic molecules to form undesirable disinfection byproducts (DBPs). Chloromethanes and chloroacetic acids are two major classes of disinfection byproducts (DBPs) commonly found in waters treated with chlorine. The addition of iron salts (e.g. ferrous chloride, ferric chloride) has been used for H₂S abatement in sewerage systems. Ferrous (Fe²⁺) forms highly insoluble metallic sulphides (FeS) allowing the removal of H₂S by precipitation. On the other hand, when ferric ion is added (Fe³⁺), H₂S is oxidized to elemental sulphur while Fe³⁺ is reduced to Fe²⁺. Use of iron salts can lead to generation of large volumes of precipitated sludge material (FeS, S) in the network. The addition of air or oxygen gas has also been used to prevent anaerobic conditions and oxidize H₂S. Wastewater can be aspirated with air or oxygen or subjected to turbulent flow to oxygenate the wastewater. The use of oxygen injection leads to only temporary oxidation of the hydrogen sulphide in the waste water and outer layers of biofilms. Similar problems have been encountered with the use of ozone gas. The addition of NO₃⁻ has been used to reduce H₂S, methanothiol and CH₄ emissions. Nitrate prevents anaerobic conditions in sewerage systems and also increases redox potential and suppresses anaerobic processes. The effects of NO₃⁻ on H₂S production has been related, amongst other things, to the competition for electrons between nitrate reducing bacteria (NRB) and SRB and the increase in pH cause by the activity of NRB.

Biofilm consists of microorganisms imbedded in a matrix the structural components of which consist of complex polymers are called extracellular polymeric substances, including microbially produced exopolysaccharides. In sewerage systems, biofilm can also contain a large fraction of inorganic material, e.g. zeolite, sand, etc, and organic material of non-microbial origin, such as fats. The spatial distribution of specific organisms within the biofilm defines the biological activity within different zones of the biofilm. The zones and processes in a typical stratified biofilm tend to anoxic the deeper into the biofilm you go. Obligate anaerobes such as sulphate-reducing (SRB) and methanogenic archaea (MA) are therefore located deep in the biofilm where they are protected from oxygen (Sun J et al, 2014). From a microbial perspective, the biofilm matrix helps to protects cells, increasing survival. The biofilm structures allow cells to remain in a favourable place. Biofilm formation allows microbial communities to live in association and interact thus favouring syntrophic relationships and allowing a complex interaction of different metabolisms to occur. Different factors, including: surface area, flow velocity near pipe walls, and nutrient availability, influence microbial colonization of sewerage infrastructure surfaces and biofilm growth. The biofilm in sewer pipes can attain significant thickness, up to tens of millimetres. The presence of biofilm in sewer pipes has many undesirable side-effects. For example, microorganisms in the biofilm are shielded from the main flow of liquid flowing through the sewer, and treating the microorganisms in the biofilm by adding treatment agents to the flow in the sewer becomes difficult because the biofilm acts to separate the treatment agents from the microorganisms.

As has been highlighted, the existence of SRB and MA, within the biofilms which develop in sewerage systems, favours the accumulation of H₂S and CH₄, causing severe impacts on sewerage systems. SRB and MA are largely reliant on the biofilm habitat for protection and survival.

In view of the above, there exists a need to develop a method for disrupting biofilm in sewerage systems which overcomes or at least ameliorates the above disadvantages, or provides a commercial alternative.

### SUMMARY OF THE INVENTION

In one aspect the invention provides a method for disrupting biofilm in wastewater systems comprising the step of adding to the system at least one biofilm disrupting dose of one or more compounds of general formula I:

R—O—O—R¹ I

wherein, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H, M⁺, C₁-C₈ alkyl, substituted C₁-C₈ alkyl, aryl, substituted aryl, C₁-C₈ acyl, substituted C₁-C₈ acyl, arylacyl and substituted arylacyl.

In some embodiments the wastewater system is a sewerage network comprised of wet wells, rising mains, gravity mains, manholes and pump stations. Preferably, the biofilm disrupting dose is added to a wet well. Suitably, the biofilm disrupting dose is delivered into a rising main downstream of the wet well.

Preferably, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H.

In some embodiments, the biofilm disrupting dose further comprises hydrogen peroxide and water.

Suitably, the delivery of the biofilm disrupting dose into a rising main comprises the steps of: substantially emptying the wet well of wastewater contained therein; adding to the wet well a quantity of recycled or fresh water of at least about 15% of the cycle volume of the wet well; delivering the added quantity of recycled or fresh water into the rising main connected to the wet well to flush at least a portion of the rising main with the water; adding to the wet well a further quantity of recycled or fresh water of at least about 15% of the cycle volume of the wet well; adding to the wet well a biofilm disrupting dose of one or more compounds of general formula I into the wet well to generate a dose fluid in the wet well; and delivering the dose fluid into a rising main.

In some embodiments, the dose fluid is acidified to a pH in the range of about pH 5 to about 7 prior to delivering the fluid to the rising main.

The method may further comprise the step treating the wastewater system with a microbiostatic agent. Suitable microbiostatic agents may be selected from: Mg(OH)₂, NaOH, Ca(OH)₂, H₂O₂, KMnO₄, and salts of Fe^{II} and Fe^{III}. 14. Preferably, the microbiostatic agent is Mg(OH)₂.

The method may further comprise the step of treating the wastewater system with an odour control agent. Suitable odour control agent may be selected from: Mg(OH)₂, NaOH, H₂O₂, salts of NO₃⁻ including Ca(NO₃)₂ and NaNO₃, salts of NO₂⁻, Ca(OH)₂, KMnO₄ and salts of Fe^{II} and Fe^{III}. Preferably, the microbiostatic agent is also an odour control agent.

The dose concentration of the compound general formula I in the wet well may be from about 1 mmol/L to about 60 mmol/L, preferably from about 2 mmol/L to about 20 mmol/L, and more preferably from about 4 mmol/L to about 10 mmol/L, with the amount of compound added to achieve the dose concentration based on the total wet well cycle volume.

Preferably, the at least one biofilm disrupting dose of one or more compounds of general formula I is peracetic acid within a formulation comprising peroxyacetic acid, acetic acid, hydrogen peroxide and water.

Preferably, the organic peroxy compound of general formula I degrades to a compound which is naturally present in the wastewater system.

In some embodiments, the at least one biofilm disrupting dose comprises two or more peroxy compounds of general formula I each of differing physico-chemical properties.

In another aspect the invention provides a biofilm disrupting formulation for use in the treatment of wastewater systems comprising two or more organic peroxy compounds of general formula I:

ROOR¹ I

wherein, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H, M⁺, C₁-C₈ alkyl, substituted C₁-C₈ alkyl, aryl, substituted aryl, C₁-C₈ acyl, substituted C₁-C₈ acyl, arylacyl and substituted arylacyl.

In yet another aspect the invention provides a method for treating biofilm in wastewater systems the method comprising the step of administering to the system a dosage of a formulation comprising a biofilm disrupting agent of general formula I:

R—O—O—R¹ I

wherein, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H, M⁺, C₁-C₈ alkyl, substituted C₁-C₈ alkyl, aryl, substituted aryl, C₁-C₈ acyl, substituted C₁-C₈ acyl, arylacyl and substituted arylacyl.

In an embodiment, the method further comprises treating the wastewater system or biofilm with an effective dosage of a biofilm disruption organic peroxy compound of general formula I over a period of time ranging from about 1 hour to about 4 days. The period of treatment may depend on, for example, the length of the rising main.

For a 5 km rising main, a 4-hour treatment may be suitable to disrupt the biofilm. For shorter mains such as 1 km, a 1-hour treatment may be appropriate. In some embodiments a 24-hour treatment is preferred.

Suitably, the substituted functional group of a compound of general formula I contributes to aqueous solubility of the peroxy compound of general formula I, for example substitution by hydroxyl or carboxylic acid groups.

Suitably, the substituted functional group contributes to enhancing the penetrative properties, of the peroxy compound of general formula I, into the biofilm mass located in the wastewater system, thereby enhancing the biofilm disrupting properties of the peroxy compound of general formula I. The penetrative properties may be enhanced by functional groups that, for example, undergo hydrogen bonding such as carboxylic acid groups and hydroxyl groups, or that interact with biofilm macromolecules via through space interactions such as Van der Waals interactions.

The applicants have surprisingly found that the organic peroxy compounds of general formula I are very effective for the in-situ disruption of biofilms found within wastewater systems.

The applicants have found that preferred peroxy compounds, of high reactivity, that is, high biofilm disrupting efficacy, have a cognate degradation product already at least in part likely to be naturally present in wastewater. This is advantageous inasmuch as the reactive peroxy compounds degrade to compounds already naturally present.

The applicants have also found that by flushing portions of the sewerage networks containing biofilms, for example portions of rising mains, with a low COD content water, such as a recycled water, COD levels around the biofilm may be reduced improving efficacy of biofilm disrupting agents by allowing for more direct targeting of the biofilm with the biofilm disrupting agent. Moreover, the flushing process reduces levels of solubilized reduced sulphur locally to the zone containing to be treated, permitting the acidified dosing of biofilm disrupting agents leading to increased efficacy and hydrolytic stability of the biofilm disrupting dose.

Furthermore, it has been found that treatment of the wastewater system with organic peroxy compounds of general formula I to disrupt biofilm accumulating or present in the wastewater system, for even a relatively short period of time, can result in a relatively long-term reduction in sulphide (such as H₂S and mercaptans) and methane production. Therefore, treatment of the wastewater system with organic peroxy compounds is likely to provide a viable strategy for controlling the activity of the sulphate reducing microbes and/or methanogenic archaea in the environment.

Moreover, the applicants have surprisingly found that microbiostatic agents, used in conjunction with organic peroxy compounds, are very effective for inhibiting the activity of anaerobic microbes such as sulphate reducing microbes and/or methanogenic archaea) in sewers. The net effect is a reduced consumption of sewer odour control agents to maintain low H₂S levels within the sewerage network.

In at least some embodiments, the invention provides an organic peroxy compound based formulation containing one or more organic peroxy compounds of general formula I specifically formulated for the purpose of adding to a wastewater system in one or more locations throughout that network.

In certain embodiments, the invention provides an organic peroxy compound based formulation containing two or more organic peroxy compounds of general formula I specifically formulated for the purpose of adding to a wastewater system a multifunctional formulation.

The experiments, in accordance with some embodiments, conducted, have found that bacteriostatic dose rates of odour control agents such as magnesium hydroxide, hydrogen peroxide, and, for example, Fe^{II} and Fe^{III} salts, are reduced by virtue of a reduction in H₂S that is brought about by the disruption of the biofilm containing the microbes that are the source of the H₂S generation.

### BRIEF DESCRIPTION OF THE DRAWINGS

The Detailed Description and Examples will make reference to a number of drawings as follows:

FIG. 1 illustrate a wet well.

FIG. 2 illustrates an Odalog™ depicting H₂S levels over an approximate 5-day period from commencement of a trial, prior to addition of Formulation 1.

FIG. 3 illustrates an Odalog™ depicting H₂S levels after a Formulation 1 was added to a sewerage network at a dosage rate of 3,300 ppm over an approximate 3-day period.

FIG. 4 illustrates an Odalog™ depicting H₂S levels when Formulation 1 was added to a sewerage network at a dosage rate of 670 ppm over an approximate 46-hour period.

FIG. 5 illustrates an Odalog™ depicting H₂S levels when Formulation 1 was added to a sewerage network at a dosage rate of 1340 ppm over period during days 49 and 50 of the trial.

FIG. 6 illustrates an Odalog™ depicting H₂S levels when Formulation 1 was added to a sewerage network at a dosage rate of 270 ppm over a 5 day period.

FIG. 7 illustrates an Odalog™ depicting H₂5 levels over an approximate 4-day period from commencement of a trial, prior to addition of Formulation 1.

FIG. 8 illustrates an Odalog™ depicting H₂S levels when Formulation 1 was added to a sewerage network at a dosage rate of 2000 ppm over an approximate 3-day period.

FIG. 9 illustrates an Odalog™ depicting H₂S levels when Formulation 1 was added to a sewerage network at a dosage rate of 500 ppm over an approximate 3-day period.

FIG. 10 illustrates an Odalog™ depicting H₂S levels when Formulation 1 was added to a sewerage network at a dosage rate of 300 ppm with an increase to 2000 ppm between the hours of 0100-0300 over days 23 to 27 of the trial.

FIG. 11 illustrates an Odalog™ depicting H₂S levels when hydrogen peroxide was added to a sewerage network at a dosage rate of 330 ppm over days 69 to 82 of the trial.

FIG. 12 illustrates an Odalog™ depicting H₂S levels when MHL was added to a sewerage network at a dosage rate of 500 ppm over days 87 to 95.

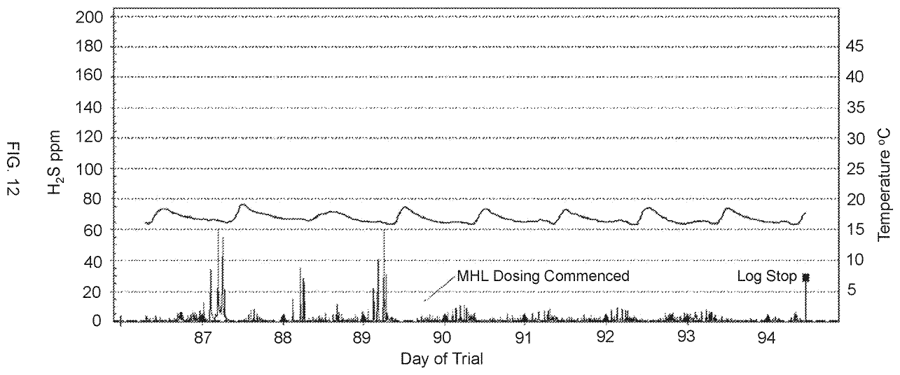

### DETAILED DESCRIPTION OF THE PREFERRED EMBODIMENTS

Definitions

Unless defined otherwise, all technical and scientific terms have the same meaning as is commonly understood by one of ordinary skill in the art to which the embodiments disclosed belong.

As used herein, the term “about” means that the numerical value is approximate and small variations would not significantly affect the practice of the disclosed embodiments. When used to describe a value, the term “about” preferably means an amount within ±10% of that value.

The articles “a” and “an” are used herein to refer to one or to more than one (i.e., to at least one) of the grammatical object of the article. By way of example, “an element” means one element or more than one element.

As used herein the term “agent” refers to a chemical substance that takes an active role or produces a specified effect.

As used herein, the term “anaerobic respiration” refers to respiration using electron acceptors other than molecular oxygen (O₂). In anaerobic respiration, substances such as sulphate (SO₄²⁻), nitrate (NO₃⁻), carbon dioxide (CO₂), or fumarate are used.

The term “biofilm” broadly refers to the exocellular structures and matrix including extracellular macromolecules and polymeric substances, e.g. mucilage, biosolids, filamentous substances formed by microbial communities, and includes the related microbiota such as bacteria and protists, that grow attached on surfaces of, and live within or on the biofilm, or are otherwise associated therewith or contained therein. Biofilm may also include substances such as insoluble particulate matter contained within the, for example, wastewater, and which may collect or deposit within the biofilm.

In the context of the present invention, biofilm within wastewater systems, such as sewerage networks, is found attached or physically adhering to surfaces of, for example: pipes, such as rising mains and gravity mains; and, chambers, such as wet wells, where said biofilm accumulates.

The term “biofilm disruption” refers to the degradation, breakdown, cleavage, oxidation or otherwise denaturing of biofilm including, for example, biofilm's loss or removal from surfaces within sewer networks.

The effect of disruption of the biofilm also includes the disruption of the synergistic interactions between consortia of microbes including the disruption of the generation of microbial metabolism by-products such as hydrogen sulphide and methane and includes the loss or reduction in density of microbiota in the wastewater system through, for example, the flushing out of biofilm from the wastewater system.

As used here in the term “chemical oxygen demand” (COD) refers to an indicative measure of the amount of oxygen that can be consumed by reactions in a measured solution. It is commonly expressed in mass of oxygen consumed over volume of solution which in SI units is milligrams per litre (mg/L).

As used herein the term “fresh water” (or freshwater) refers to any naturally occurring water except seawater and brackish water. Fresh water is generally characterized by having low concentrations of total dissolved salts and other dissolved solids.

As used herein the term “recycled water” refers to wastewater that has been converted into water to be reused for other purposes. Recycled water may be highly treated wastewater that has been filtered to remove solids and other impurities as well as disinfected by a water treatment plant.

As used herein the term “microbiocidal” refers to the destruction, deterrence, rendering harmless, or exertion of a controlling effect of or on microbiota. By extension, related terms such as “microbiocidal agent” and “microbiocidal dose” respectively refer to agents and dosing concentrations that are microbiocidal.

As used herein the term “microbiostatic” refers to the inhibition of growth or multiplication of microbiota. By extension, related terms such as “microbiostatic agent” and “microbiostatic dose” respectively refer to agents and dosing concentrations that induce microbiostasis.

As used herein the term “odour control agent” refers to an agent that reduces emissions of an odoriferous substance. Odoriferous substances include the class of reduced sulphur compounds (RSCs), for example: hydrogen sulfide (H₂S), methanethiol (MeSH), dimethylsulfide (DMS), carbon disulfide (CS₂), dimethyl disulfide (DMDS) and dimethyl trisulfide (DMTS), biphenyl sulphide. Odoriferous substances may also be classed as volatile sulphur compounds (VSCs), which are divided into Volatile Organic Sulphur Compounds (VOSCs) and inorganic compounds (e.g. H₂S). Odour control agents include: sulphide scavengers; sulphide sequestering agents, sulphide partitioning compounds and competitive reduction species. Examples of odour control agents include Mg(OH)₂ slurries, NaOH, H₂O₂, salts of NO₃⁻ including Ca(NO₃)₂, NaNO₃, salts of NO₂⁻, Ca(OH)₂, Fe^{II} and Fe^{III} salts, and KMnO₄.

As used herein, the term “sewage” refers to wastewater, excrement and other effluent conveyed in sewers.

As used herein, the term “sewer”, refers to an underground conduit for carrying off wastewater including drainage water and waste matter.

As used herein, the term “dose”, refers to a quantity to be administered.

As used herein the term “dosage” refers to the prescribed administration of a specific amount, number, and frequency of doses over a specific period of time.

As used herein, the phrase “ biofilm disrupting dosage” refers to the quantity, administered over one or more doses over a prescribed period of time, of an agent administered to elicit the required effect, which in the context of the present disclosure is an organic peroxy compound of general formula I. For example, an effective biofilm disrupting dosage, of an organic peroxy compound of general formula I, is the dosage that elicits the biofilm disrupting response that is being sought in the wastewater system by an operator.

As used herein the term “C₁C₈ alkyl” refers to a 1 to 8 carbon, straight or branched, alkyl chain. Similarly, “C₁-C₇ alkyl” would refer to 1 to 7 carbon equivalents.

As used herein the term “substituted C₁-C₈ alkyl” refers to a 1 to 8 carbon, branched or straight, alkyl chain substituted with at least one functional group. Suitable functional groups include: hydroxyl, carboxylic acid, ester, keto, aldehyde, —C(O)—O—OH, —O—OH, ether, and double bonds. Similarly, “substituted C₁-C₇ alkyl” would refer to 1 to 7 carbon equivalents.

As used herein the term “aryl”, refers to an aromatic hydrocarbon group.

As used herein the term “substituted aryl”, refers to an aromatic hydrocarbon group substituted with at least one functional group. Suitable functional groups include: C₁₋₃ Alkyl, hydroxyl, carboxylic acid, ester, keto, and aldehyde groups.

As used herein the term “C₁-C₈ acyl”, refers to group of formula R₁C(O)— where R₁ may be C₁₋₇ alkyl.

As used herein the term “substituted C₁-C₈ acyl” refers to a group of formula R₂C(O)— where R₂ refers to a 1 to 7 carbon, branched or straight, alkyl chain substituted with at least one functional group. Suitable functional groups include: hydroxyl, carboxylic acid, ester, keto, aldehyde, —C(O)—O—OH, —O—OH, ether, and double bonds.

As used herein the term “arylacyl” refers to a group of formula R₃C(O)— where R₃ refers to an aromatic hydrocarbon group.

As used herein the term “substituted arylacyl” refers to a group of formula R₃C(O)— where R₃ refers to an aromatic hydrocarbon group substituted with at least one functional group. Suitable functional groups include: alkyl, alkoxy, carboxylic acid, hydroxyl, ester, keto, and aldehyde groups.

The term “plurality” means “two or more”, unless expressly specified otherwise. For example, “plurality” may simply refer to a multiplicity of microparticles (two or more) or an entire population of microparticles in a given composition or dosage form, e.g., for purpose of calculating the size distribution of the microparticles.

As used herein, unless specifically indicated otherwise, the word “or” means “either/or,” but is not limited to “either/or.” Instead, “or” may also mean “and/or.”

As used herein, the term “wet well” refers to a holding sump for sewerage systems. As sewage enters the wet well and the water level rises, pumps are engaged to pump out the sewage to a rising main, or the sewage is lifted to a higher grade to continue the gravity flow to the outlet point. Wet well volumes can range from hundreds of litres to tens or even hundreds of thousands of litres. Typically, wet wells operate with waste water quantities less than their actual total volume, for example, about 10% to about 20% of the total wet well volume. This reduced operational volume is referred to as the “cycle volume”.

As used herein the terms “pump station”, “pumping station”, and “sewer pumping station” (SPS) in wastewater collection systems, refer to a pumping system designed to handle wastewater that is fed from underground gravity pipelines. Such stations are typically located at inlets of rising mains.

As used herein the term “wastewater” refers to effluent water that has been used in the home, in a business, or has been generated or used as part of an industrial (including primary industry) process. Examples of wastewater include: sewage, sewer water, sour water from oil and gas processing, wastewater in settling ponds and lagoons: for example, from piggeries (treating pig manure), chicken farms (chicken manure), olive refineries, wineries, dairy farms and landfill site leachate.

The collection of pipes, chambers such as wet wells, manholes, pump stations, etc., that convey sewage is known as a “sewerage network”. A “sewerage network” may also sometimes be referred to as a “sewer network”. Components of a sewerage network include: receiving drains, rising (or force) mains, wet wells, gravity mains, receiving manholes, pumping stations and storm overflows. Sewerage systems are implemented for the collection of wastewater and transportation of that wastewater. A sewerage network typically ends at the entry to a sewage treatment plant or at the point of discharge into the environment. Dosing of a sewerage network may be referred to as network dosing.

The “rising main” also known as a “force main” is typically a type of drain or sewer pipe through which wastewater and/or surface water runoff is pumped under pressure. The rising main sections are designed and operated to pump the sewage to a higher altitude and have no gas phase present within the pipes. Rising mains commonly discharge into a gravity main via a receiving manhole.

In the gravity flow regions, the wastewater flows (due to gravity) down gravity mains and these mains are mostly partially filled with sewage and thus have a gas phase or headspace. Rising mains can range in length from a few hundred meters to 10 s of kilometres long. Typically rural rising mains are longer than those in urban and suburban locations or where sewage treatment plants have been consolidated over the years and/or bypassed or transferred to distal treatment plants.

The hydraulic retention time (HRT) in a rising main may depend on the length of the rising main. For example, depending on flow and demand, HRTs may be much longer in long rising mains. The term “hydraulic retention time” (HRT) refers to the period of time influent spends within a defined volume. For example, if the HRT of a section of rising main is 24 hours, it means that it takes 24 hours for the volume of fluid within that section of rising main to be turned over or replaced. Gases may be generated and collect within rising mains that have a long HRT (i.e. >2 hours).

Hydrogen sulphide production in sewerage systems can occur through the activity of sulphate reducing microbes in biofilm located in the rising mains, but also in the anaerobic sections of gravity pipes and wet wells. Long rising mains may be particularly susceptible to H₂S production due to lack of oxygen, septicity, and SRM colonies.

A rising main is a main under pressure from a pump station. Most biofilm growth is in the rising main. The exit of a rising main may be a receiving manhole or may, more typically, be another pump station. These locations may be susceptible to emissions build up odour and/or corrosion problems. Sewerage systems are dynamic in nature with periodic variations of hydraulic flow and wastewater substrate concentrations. Biofilm activities vary significantly with location, with biofilm corresponding to the start of the rising main indicated as capable of greater sulphide and VFA production than biofilm downstream. That biofilm activity may vary along the length of a rising main should be taken into account when considering the effect of biofilm management.

Typically, there is a headspace in the rising main when the pump is not running. There is significant variability in the time the rising main is full. Main locations of gaseous headspaces are: manholes, pump stations, gravity sewer and the rising mains (in between pump cycles). Receiving manholes are at the top of the rising main and may be 1-2 metres deep. There may be 3-4 rising mains meeting at the receiving manhole. Gravity mains drain away down the hill from the receiving manhole.

Dosing Locations

The biofilm disrupting effect of a peroxy compound of general formula I, when added to a wastewater system as a biofilm disrupting agent, may be dependent upon: the location of dosing within the system being treated, the location of the biofilm within the system, and the biological effect desired. As such, the location of the dosing of peroxy compounds of general formula I in the wastewater system, location of the biofilm within the system, dose rate and concentration of the biofilm disrupting formulation containing the biofilm disrupting agent, and the delivery method, combine to form the basis for a wastewater network odour control system that works (on its own or) synergistically with microbiostatic agents and other odour control products that can control SRM levels in sewage networks.

Sewerage network problems related to anaerobic respiration may be identified through various means such as: a public complaint about foul odour at a particular location, e.g. from a manhole, municipal or third-party odour logging within the network or operator observation of the network. For example, operator identified corrosion in receiving manholes may be an indicator of H₂S generation.

For even longer rising mains, vent pipes and breathers can also be considered as dosing locations. Organic peroxy compounds of general formula I are always best dosed into the water stream and contact with infrastructure (concrete, metal, pumps etc) should generally be avoided.

Once the location of a network problem has been identified, for example: biogenic corrosion, gas build-up within the network, or emissions from the network, a dosing location may be determined so as to target the biofilm generating the emissions. Typical dosing location include wet wells and at receiving manholes.

It is preferable that the organic peroxy compound of general formula I is dosed as closely as possible to the location in the sewerage system where anaerobic respiration is occurring. This is so as to more effectively target the biofilm responsible for generating the problem emissions.

If dosing is too far upstream from the location of the biofilm the organic peroxy compound may be, for example, consumed by reactive COD in the wastewater and rendered ineffective against biofilm in a location implicated in generating the problem emissions. In some instances, the applicant determined that a 5 km rising main was about the extent along which an organic peroxy compound (in that case PAA) was found to persist above the limit of detectability. However, the extent may depend on environmental factors. For example, in other instances, the applicant has determined that due to high levels of reactive organic substrates (reactive COD that may include organics substrates, biofilm and microbiota) within the reactive main, peracetic acid may fall to below the limits of detectability, within only a kilometre of the dosing location.

Suitably, the organic peroxy compounds may be dosed into the start of a rising main during the pump cycle. When dosing long sections of a problematic rising main pipeline, dosing at intervals along the pipeline may be required. Suitably, dosing may be timed to occur just prior to commencement of new pump cycles. Suitably, for prophylactic purposes, locations within the network prior to rising mains, or locations that are prone to odour complains are preferentially dosed.

Wet wells frequently precede rising mains and present suitable locations for dosing the organic peroxy compounds of the present invention. The dosing location and the dosage rate determine effectiveness and associated cost. Once the biofilm has been dispersed, H₂S production is dramatically reduced. One of the net effects of disrupting the biofilm and reducing the level of biofilm activity is that any odour control agent will have a significantly reduced demand to maintain low H₂S levels within the sewerage network. The effectiveness of a dosing regime may be determined by monitoring the system for, for example, H₂S or mercaptans. Care should also be taken when dosing with organic peroxy compounds closely upstream of a wastewater treatment plant.

Dosing

Within a live sewerage network, sewer water continues to flow typically 24 hours a day. In order to minimise disruptions, for example, to the consumer and to network services, dosing, where possible, should be a brief as practicable. As such, in order to optimise efficient biofilm disruption, it is preferable to employ the highest practical concentrations of peroxy compound of general formula I when dosing into the sewerage network such as into a wet well. For example, when dosed directly into raw sewer water, the peroxygen compound must be dosed at a sufficiently high enough concentration such the peroxygen compound of general formula I, is not completely consumed by the inherent COD that naturally exists in the sewer water, and that a sufficient concentration of the peroxygen compound remains to act on the biofilm within the system.

The concentration of organic peroxy compound of general formula I needed to elicit the disruptive response can be estimated based on factors such as: temperature, gas concentrations, COD, thickness of biofilm, inputs to the system including domestic or industrial waste, network operations such as hydraulic retention times, pump rates, pump flows and the like.

What constitutes an effective, or biofilm disrupting, dosage of an organic peroxy compound of general formula I may depend on environmental factors within the wastewater system. For example, the peroxy compound of general formula I may react with (and therefore be consumed by) dissolved or suspended organic molecules and particles within wastewater and/or other oxidizable inorganic species (e.g. H₂S) within the wastewater itself. For example, peracetic acid may react with proteinaceous material, experimental results have demonstrated that the amino acids cysteine (CYS), methionine (MET), and histidine (HIS) react with peracetic acid. (Penghui Du et al, 2018). Peracetic acid also reacts to oxidize hydrogen sulphide. As such, if too low a dose of the organic peroxy compound is administered to the sewerage system, then that organic peroxy compound may be consumed, for example, by the reactive COD in the wastewater, or H₂S in the system, before sufficient quantities of the peroxy agent reach the intended target of the biofilm including related biota.

Suitably, the dose concentration of the biofilm disrupting agent of general formula I is from about 1 mmol/L to about 60 mmol/L, preferably, from about 2 mmol/L to about 20 mmol/L, more preferably from about 4 mmol/L to about 10 mmol/L, with the amount of the agent to be added to achieve the desired concentration based on the total wet well cycle volume. For example, if the wet well has a volume of 10,000 litres, and the cycle volume is 20% of the total wet well volume, then the cycle volume is 20001. Furthermore, if the desired dose concentration of the agent is 6 mmol/L (based on the total wet well cycle volume), then the amount of agent to be added to the wet well is that amount required to give a concentration of 6 mmol/L in a volume of 2000 litres. To continue with the example, if the wet well with the cycle volume of 2000 litres is to be dosed with a peracetic acid formulation containing 15 wt % peracetic, then the amount of peracetic acid formulation to be added to achieve the desired concentration would be 6 litres.

Suitably, the biofilm disrupting dose rate has a rapid and significant impact on resident populations of SRM and MA in the wastewater system. Typically, indicators of a successful dosage are when peak concentrations of H₂S are ≤20 ppm and average concentrations of H₂S ≤1 ppm. Typically, redosing may be required within a period of between 6-18 months, more typically between 12-18 months, when the indicated signs of H₂S levels and mercaptan presence are not being managed at target levels while using the biostatic agents. For example, when H₂S readings return an average of greater than 5 ppm with spikes >20 ppm at the location of the originally identified sewerage network problem.

A preferred class of organic peroxy compounds for use in formulations as biofilm disrupting agents, are peroxycarboxylic acids of general formula II:

R²C(O)—OH II

where R² is selected from Cₗ₋₇ alkyl, substituted C₁-C₇ alkyl, aryl and substituted aryl.

Suitably, the biofilm disrupting formulations for use in the methods of the present invention comprise a peroxy carboxylic acid of general formula II. Preferably the biofilm disrupting formulation comprises mixture of a compound of general formula II, the cognate carboxylic acid of the compound of general formula II, hydrogen peroxide and water. In some embodiments the mixture is an equilibrium mixture.

Typically, the chemical class of peroxycarboxylic acids has the highest oxidation potential of all organic peroxides, rendering them as effective oxidizers. A compound's solubility in water is at least in part dependent on the length of the alkyl chain. For example, whilst lower molecular weight peroxycarboxylic acids typically dissolve readily in water, longer chain peracids become more insoluble. For example, peroxyoctanoic acid is slightly soluble in water, whilst peroxydodecanoic and peroxyoctadecanoic have very limited solubility (at pH 7).

A particularly preferred peroxycarboxylic acid compound generally formula II is peroxyacetic acid, also referred to as peracetic acid (PAA). Commercial peracetic acid solutions are typically provided as a mixture of peracetic acid, hydrogen peroxide, acetic acid and water. Peracetic acid biofilm disrupting activity is thought to function through denaturing proteins, disrupting cell walls, and oxidizing sulfhydral and sulfur bonds in proteins, enzymes, and other metabolites.

Formulations of peracetic acid are typically sold as equilibrium mixtures of peracetic acid, acetic acid, and hydrogen peroxide of varying strengths. The concentration of the peracid as the active ingredient may vary. An indicative list of typical commercially available peracetic acid formulations is provided in Table 1 below:

TABLE 1
List of Peracetic Acid Formulations

| | Peracetic | Hydrogen | Acetic | Water | |
|---|---|---|---|---|---|
| | Acid wt % | Peroxide | Acid (wt %) | (wt %) | H₂SO₄ |
| No. | (CH₃CO₃H) | (wt %) H₂O₂ | CH₃CO₂H | H₂O | (wt %) |
| 1 | 5 | 23 | 15 | 57 | |
| 2 | 12 | 18.5 | 20 | 49.5 | |
| 3 | 15 | 10 | 30-40 | balance | |
| 4 | 15 | 23 | 16 | 45 | 1 |
| 5 | 22 | 5 | 42-50 | balance | |
| 6 | 25 | 5 | 45 | 25 | |
| 7 | 35 | 6.5 | 40 | 18 | |
| 8 | 35 | 6.5 | 40 | 17 | 1 |

In some instances, a portion of the peracetic acid may be consumed by reaction with hydrogen sulphide. The applicants have hypothesized that the hydrogen peroxide contained in the above formulation acts synergistically with peracetic acid inasmuch as when the formulation is dosed into the sewerage system, the hydrogen peroxide in the formulation reacts with reduced sulphur species in the system acting to mop up reduced sulphur species such as hydrogen sulphide. The action of hydrogen peroxide means that potentially less peracetic acid is consumed by reaction with H₂S and thus more of the peracetic acid is free to react with the biofilm. Accordingly, in some embodiments a dosing formulation, with a higher relative proportion of H₂O₂, such as, for example, formulations No. 2 and No. 4 in Table 4 above are preferred.

Accordingly, in sewerage system where high levels of H₂S are already present, it may be advantageous to first dose with a sulphide sequestering agent such as, for example, hydrogen peroxide. Alternatively, formulations of the present invention containing organic peroxy compounds may be modified by the addition of hydrogen peroxide to provide a co-dosing formulation. Pre-dosing with hydrogen peroxide may allow for less subsequent consumption of peracetic acid within the sewerage system. Reactions of hydrogen peroxide with sulphur compounds are displayed in equations i)-v) below:

i) H₂S+H₂O₂→S+2H₂O

ii) Na₂S+4H₂O₂→Na₂SO₄+4H₂O

iii) 2RSH+H₂O₂→RSSR+2H₂O

iv) RSR+H₂O₂→R₂SO+3H₂O

v) 2RSH+H₂O₂→RSSR+2H₂O

Suitably, pre-dosing with a formulation of hydrogen peroxide may occur where high concentrations of H₂S have been identified as already present, for example, concentrations greater than 500 ppm of H₂S in the headspace. Accordingly, in some embodiments a formulation of H₂O₂ is dosed into the sewerage system at the dosing location at least a few minutes prior to addition of peracetic acid.

Against many substrates, peracetic acid has fast reaction kinetics, requiring short contact times for disinfection. Dosage time periods for peracetic acid may be a short as four hours. The standard oxidation potential (at pH 7) of PAA is higher than most common oxidants (Table 2).

TABLE 2
Oxidation Potential

| Oxidant | Oxidation Potential (eV) |
|---|---|
| Hydroxy Radical | 2.8 |
| Ozone | 2.07 |
| Peracetic Acid | 1.81 |
| Hydrogen Peroxide | 1.78 |
| Potassium Permanganate | 1.68 |
| Chlorine Gas | 1.36 |
| Chlorine Dioxide | 0.95 |
| Sodium Hypochlorite | 0.94 |

Peracetic acid is typically more reactive at higher temperature (5 times more reactive at 35° C. than 15° C.). It has been observed by the applicant that although the oxidation potential of peracetic acid is very similar to hydrogen peroxide, peracetic acid displays a stronger biofilm disrupting activity that hydrogen peroxide. Similarly, it has been observed by the applicant that although the oxidation potential of peracetic acid is lower than ozone, peracetic acid displays a stronger biofilm disrupting activity than ozone. This is believed to be due to the nature and type of radicals formed upon cleavage of the peracetic acid peroxy bond.

Hydrolytic Stability

The resistance of a compound to hydrolysis (chemical decomposition of the compound in the presence of water) is referred to as “hydrolytic stability”. The hydrolytic stability of peroxy compounds of general formula I, such as peroxycarboxylic acids, may be pH dependent. For example, Table 3 below (Regulation (EU) No 528/2012) indicates the hydrolytic stability of peroxyacetic acid at alkaline, neutral and acidic pH. A reduction or minimization in the hydrolytic decomposition of a biofilm disrupting agent of general formula I would lead to, consequently, a greater portion of the agent dosage available for biofilm disruption and would thus improve the potential efficacy of the agent dosage.

TABLE 3
Hydrolytic Stability of Peroxyacetic Acid

| pH | DT₅₀ (25° C.) |
|---|---|
| 4 | 46.7 hours |
| 7 | 31.7 hours |
| 9 | 3.6 hours |

Suitably, the peroxy compound of general formula I has a hydrolytically stable (DT50) of at least about 30 mins at pH 7. Preferably the peroxy compound of general formula I has a hydrolytically stable (DT₅₀) of at least about 1 hour, more preferably at least about 10 hours, and even more preferably at least about 25 hours at pH 7. In some embodiments, the hydrolytic stability of the organic peroxy compound of general formula I may be increased by decreasing the pH. In some embodiments, the pH of the sewerage network, for example the wet well and/or rising main, may be decreased prior to, or concomitantly with, dosing to the sewerage network of a biofilm disrupting agent of general formula I. In other embodiments, the pH of the portion of dosing fluid containing the biofilm disrupting agent of general formula I, may be adjusted prior to addition to the network.

For example, and in view of the above table, dosage of formulation comprising a peroxycarboxylic acid as a biofilm disrupting agent into a wet well containing wastewater or other aqueous fluid that is of about neutral to acidic pH may be preferable in order to decrease the hydrolytic instability of peroxycarboxylic acid. The pH adjustment of a wet well may be achieved by ceasing the dosing of alkali in the preceding wet wells that supply the target wet well. This would allow the sewer water to naturally acidify over time leading to a natural reduction in pH. By monitoring the pH of the sewer water, a suitable dosage time may be identified. Any acidification method needs to consider the pH dependent solubility of bisulphide (HS⁻) within the sewer effluent, and the concentration of the bisulphide therein. Under increasing acidic conditions bisulphide is converted to H₂S and which then begins to degas from the effluent (Table 4).

TABLE 4
Bisulphide solubility versus pH

| | |
|---|---|
| Bisulphide (HS⁻) | Hydrogen Sulphide (H₂S) |

| | |
|---|---|
| pH | Mole Fraction of Species (%) |

| | | |
|---|---|---|
| 4 | <1 | >99 |
| 5 | ~1 | ~99 |
| 5.5 | 3 | 97 |
| 6.0 | 9 | 91 |
| 6.5 | 24 | 76 |
| 7.0 | 50 | 50 |
| 7.5 | 76 | 24 |
| 8.0 | 91 | 9 |
| 8.5 | 97 | 3 |
| 9.0 | ~99 | ~1 |
| 10.0 | >99 | <1 |

A preferred method of administering a formulation containing a biofilm disrupting agent of general formula I to a wet well, would be to add the formulation to a wet well containing a low COD, low dissolved solids (including dissolved salts) aqueous fluid, said fluid with a pH in the range of about pH 5-7.5, preferably within the range of pH 6-7.

The pH adjustment of the wet well may be achieved through the substantial emptying of wastewater from the wet well and the addition of fresh or recycled water to the wet well which is subsequently acidified. For example, the pump station upstream of the wet well may be temporarily switched off, the wet well substantially purged of sewer water, and water such as: fresh water, recycled water or other water with low COD and dissolved salts, is added to the wet well where it is acidified with an acid such as mineral acid to pH 5-7.5 preferably 6-7, and then the biofilm disrupting agent is mixed in to this lower COD water contained in the wet well water at a pH level that reduces the hydrolytic instability of the peroxy compound of general formula I in solution in the wet well.

Suitably, when added into freshly acidified water, following pump out of the wet well, to generate a biofilm disrupting dose within the wet well, the amount of the formulation containing the peroxy compound of general formula I that added to the water results in a concentration of the peroxy compound of about 6 mmol/L to about 26 mmol/L, preferably about 10 mmol/L to about −30 mmol/L, based on the wet well cycle volume. Preferably, the high concentration acid stabilized dosage is pumped into the rising main with a shorter contact time. A short contact time facilitates a quicker transition to resuming raw sewer pumping without significant interference to the network flows. Typically, longer transition times means that raw sewer water would need to be, for example, diverted or captured by other means.

Delivery Methods

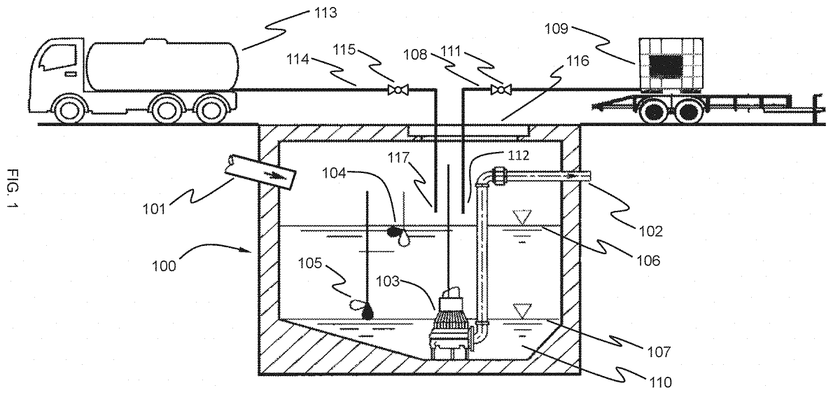

Referring to FIG. 1, a wet well 100 typically has a sewer inflow port 101 and a sewer outflow port 102 connecting the wet well to a rising main. The wet well pump 101 cycles operate on a, fill to a high-level sensor 104, then pump out, or discharge, to a low-level sensor 105, cycle. These pumping operations typically occur automatically. However, the timing, over the cycle, of the addition of the biofilm disrupting formulation containing the peroxy compound of general formula I as a biofilm disrupting agent, may have an effect on the actual concentration of the biofilm disrupting agent within the wet well. For example, if the agent is added at the top 106 (fill to high) point of the cycle then the concentration of the active agent in the wet well will be different than if added at the bottom 105 (pump out to low) end of the cycle. Accordingly, and depending on the wastewater water level within the wet well 100, there will be a change to the concentration of the active peroxy compound of general formula I that is exposed to the biofilm in the rising main. For example, the timing of dosing could see the concentration of the peroxy compound of general formula I increase to about 20 mmol/L-40 mmol/L when added towards the bottom end of the wet well cycle, even though dosed, for example, on an ˜6 mmol/L basis of organic peroxy compound of formula I, (based on total wet well cycle volume). Adding the biofilm disrupting formulation towards the bottom end of the pump cycle may also have the effect of allowing the formulation to be more rapidly delivered into the rising main at a higher concentration. Accordingly, in some embodiments, the biofilm disrupting formulation is added to the wet well towards the bottom end of the discharge cycle such that dosing is commenced when there is about 20% to about 50%, of the wet well cycle volume remaining such the concentration of the biofilm disrupting agent in the formulation may be increased by about 2 to about 5 times and a more concentrated but smaller volume of wastewater containing the biofilm disrupting formulation is delivered into the rising main.

Returning to FIG. 1, typically, the formulation containing the organic peroxy compound of general formula I is added, for example, piped 108 from an Intermediate Bulk Container (IBC) 109 directly into the wet well raw sewer water 110 during the filling stage of the wet well 100. The addition may be controlled or stopped such as with a valve 111. Care is taken using a stainless-steel dip pipe 112, which may be raised or lowered as required, to deliver the formulation directly to the water surface avoiding touching any infrastructure in the wet well 100 due to the corrosive nature of most organic peroxy formulations. Continuing with FIG. 1, a preferred method of adding a biofilm disrupting dosage of a compound of general formula I is now described. Towards or at the bottom of the pump cycle the sewerage pump station (SPS) pump, upstream of the wet well to be dosed, is temporarily suspended via contact with the sewerage network control room. A suitably quantity of fresh or recycled water, for example about 15% to about 50% of the wet well cycle volume, preferably about 20% to about 30% of the cycle volume, is delivered or pumped from a road tanker 113 via transfer line 114 through outlet 117 into wet well 100. The flow of the water from the supply 113 may be controlled for example by valve 115. Additions of water and biofilm disrupting formulations are through hatch 116 into wet well 100. Pump 103 is then actuated and the added water is pumped from wet well 100 through the sewer outflow 102 into the rising main to commence flushing of the rising main. After the first portion of flush water has been pumped into the rising main, a second portion of fresh or recycled water, in a quantity from about 15% to about 50%, preferably from about 20% to about 30%, of the wet well cycle volume, is subsequently pumped from the water supply 113 into the wet well 100. Optionally, during addition of the second portion of water, a mineral acid such as hydrochloric acid may be added to the wet-well, or mixed into the pumped stream of water from tanker 113, so as to reduce the pH of the final volume of the second portion of water in the wet well to a pH of about 6-7.5, preferably to a pH of about 6-7. Either concomitant with, or after, the second portion of water has been added, a dose of biofilm disrupting formulation containing on organic peroxy compound of general formula I, is added from the IBC 109 directly into the wet well 100 via transfer line 108 to generate a dose fluid, as a mixture of the formulation of the organic peroxy compound of general formula I, fresh or recycled water, and optionally a mineral acid, in wet well 100. Once the organic peroxy compound of general formula I has been added, the wet well pump 103 is re-actuated and the dose fluid is pumped from the wet well 100 into the rising main until the wet well 100 is substantially or nearly empty. The process of adding flush water and flushing the rising main followed by generating dose fluid and pumping it into the rising main, is repeated until such time as an equivalent of about 5% to about 30%, preferably about 10% to about 20% of the rising main volume has been filled with successive portions of flush water and dose fluid.

As the alternating portions of flush water and dosage fluid reach the receiving manhole after traveling through the rising main, the pH of the fluid in the receiving manhole is raised with a pH modifier, such as magnesium hydroxide slurry, to achieve a pH of about 8.2-8.5.

It has been observed by the applicant that after commencement of dosing of the biofilm dispersing agent, the first few pump cycles (˜10 sewer pumps) are black with heavily dispersed biofilm particles indicating that biofilm has been cleaved from the surfaces within the network by the biofilm disrupting agent of general formula I. Another indicator of the effectiveness of dosing is olfactory indication and H₂S monitoring.

One advantage of disrupting biofilm with a formulation comprising an organic peroxy compound of general formula I is that there is a significant reduction in conversion costs for a network with existing infrastructure for odour control. The reduction in the population of SRB due to disruption of biofilm, within that section of the network being treated, will affect all odour control agent consumption demand since the usage of these chemicals is a function of how much H₂S is produced.

Microbiostatic Agents

Once the dosage of a biofilm disrupting agent of general formula I to the wastewater system has been completed, and H₂S results shown to respond to the action, a biostatic agent is preferably added to the wastewater system. Advantageously, after disruption of the biofilm with an organic peroxy compound, a biostatic agent can be dosed into the sewerage system that now contains a reduced microbial population count. On the basis that a sewerage system that has not been dosed with a biofilm disruption agent has a higher H₂S and methane emission potential, due to higher populations of SRB and MA in active biofilm, a biostatic agent dosed into that system may inhibit continued growth of the biofilm but the system will already be potentially emitting higher levels of H₂S and methane (due to the higher populations). After biofilm disruption, the ensuing reduced emissions are directly as a result of destruction of the biofilm and the microbes contained therein. On this basis, that is, after dosing with organic peroxy compound of general formula I as a biofilm disrupting agent, a microbiostatic agent may be found to have increased efficacy, as the microbiostatic agent acts to maintain a microbial population at the lower level in the system resulting from biofilm disruption.

Suitably, the microbiostatic agent is selected from: Mg(OH)₂, NaOH, Ca(OH)₂, H₂O₂, KMnO₄, and salts of Fe^{II} and Fe^{III}. Preferably the biostatic agent prevents biofilm regrowth.

In some embodiments, the wastewater system is further dosed with an odour control agent. Suitably, the odour control agent is selected from: Mg(OH)₂, NaOH, H₂O₂, salts of NO₃⁻ including Ca(NO₃)₂, NaNO₃, salts of NO₂⁻, Ca(OH)₂, KMnO₄ and salts of Fe^{II} and Fe^{III}.

Preferably the biostatic agent also acts as an odour control agent. In some embodiments the odour control agent partitions hydrogen sulphide as bisulphide in wastewater.

One preferred microbiostatic agent of the present invention is magnesium hydroxide liquid (MHL). MHL is a slurry of magnesium hydroxide (Mg(OH)₂) in water. Typically, the magnesium hydroxide concentration is about 30%-65% w/w. The slurry may contain traces of other materials such as crystalline silica (Quartz) typically less than about 1% w/w and calcium hydroxide (Ca(OH)₂) typically less than about 2% w/w. The pH of the slurry is typically 11-12. MHL may be added directly to a sewerage network, from a storage tank, with a suitable dosing pump.

The bacteria and other biological entities which play an active role in wastewater treatment are most effective at a neutral to slightly alkaline pH of 7 to 8. Most methanogenic species grow best within a pH range from about 6.5 to 8 (Ken Anderson et al 2003)

Typically, magnesium hydroxide slurry is much safer to handle than caustic soda, and does not scale equipment like hydrated lime. Magnesium hydroxide provides more CaCO₃ equivalent alkalinity on an equal weight basis when compared to hydrated lime and caustic soda, which lowers chemical consumption. Additional benefits to MHL are its buffering ability, which provides the added benefit of excellent pH control, and its handling properties. Unlike caustic soda, magnesium hydroxide is non-hazardous and non-corrosive when used properly which makes handling safer and easier.

Typically, MHL slurry is dosed to provide a pH of about 9.2 at a pump station in order to target a pH of 8.2-8.5 at the exit of the rising main. Within the above pH range 95% of hydrogen sulphide (HS⁻) is solubilised.

MHL increases the pH of the wastewater, for example raising the pH from in the range of pH 6.8 to 7.9 to the range of pH 8.5 to 9.0. This increase in alkalinity has the effect of solubilising the sulphide in the wastewater thus maintaining a greater portion of the sulphide in the liquid phase. This in turn decreases the concentration of gaseous H₂S emission in available headspaces in the sewerage system. Thus, overall emissions of H₂S from the sewerage system are reduced.

It has been hypothesised by the applicant that magnesium hydroxide liquid has an alkalinity based inhibitory effect on extracellular polymeric substances (EPSs). Once the biofilm has been disrupted and displaced, the alkalinity reduces the ability of the sticky extracellular substance to hold together and re-form the biofilm again.

Dimethyl sulphide may be formed by the bacterial metabolism of methanethiol. Mercaptans, also known as thiols, are naturally occurring from the degradation of sulphur containing organics (proteins, etc.). Methanethiol may form, for example, through the degradation of methionine. Methanethiol may also form through the transmethylation of hydrogen sulphide. Anaerobic bacteria have been observed to methylate H₂S and methyl mercaptan. Dimethyl sulphide may form from the methylation of methane sulphide and methanethiol oxidation. Accordingly, it is evident that some sulphur containing compounds appear to originate from methionine degradation and not sulphur respiration. In some embodiments, the methods of the present invention are also directed towards the abatement of odoriferous compounds such as methane thiols.

Activity of Organic Peroxy Compounds

Effective dispersion of the organic peroxide compound within the biofilm may facilitate biofilm disruption. It has been hypothesized by the applicant, that the organic moiety of organic peroxy compounds of general formula I may assist in penetration and permeation of these compounds within the biofilm thus improving their efficacy. For example, alkyl and/or aryl peroxyacids (and the substituted versions thereof) may demonstrate greater penetration into anaerobic microbe biofilm due to presence of the substituted or unsubstituted alkyl or aryl moieties on these molecules. For example, the presence of hydrophilic substituents, such as hydroxyl groups, on alkyl or aryl moieties, may further assist in penetration, permeability and transport of the peroxide compounds within the extracellular matrix. For example, the hydrophobicity of the organic moiety may aid in the permeation through hydrophobic lipid layers that can often exist due to the nature of the dispersed fats, oils and grease in wastewater.

Furthermore, the applicant has also hypothesized that the structural similarity of the relatively low molecular weight peroxide compounds of general formula I to cognate compounds that naturally occur within the biofilm aquatic microenvironment, facilitates the uptake, transport and transfer of compounds of general formula I within the microenvironment. Examples of peroxides and their cognates are displayed in Table 5.

TABLE 5
Peroxides and Cognate Compounds

| Peroxide | Cognate |
|---|---|
| Peroxyacetic Acid | Acetic Acid |
| Peroxypropanoic Acid | Propionic Acid |
| Hydroperoxyethane | Ethanol |
| Peroxybenzoic Acid | Benzoic Acid |
| Peroxyformic Acid | Formic Acid |

Peroxy compounds typically breakdown into radicals with scission of the O—O bond linkage forming degradation products. The bactericidal activity of peroxy compound may derive from the generated breakdown radicals such as hydroxy radicals and organic radicals. Organic radicals may be stabilized and have a longer half-life than hydroxy radicals and therefore persist for longer leading to improved effectiveness.

Examples of degradation products expected to be already present in wastewater systems containing biofilms include: volatile fatty acids such as formic acid, acetic acid, propanoic acid, butanoic and acid; glutaric acid; benzoic acid, malic acid; pyruvic acid; fumaric acid; citric acid; lactic acid; maleic acid; succinic acid; ascorbic acid, butanedioc acid, adipic acid and oxalic acid. For example, the degradation products of peroxyformic acid are performic acid and water. Formic acid is not toxic to aquatic fauna and easily biodegradable.

Preferably, the organic peroxy compounds described in the current disclosure irreversibly react with organic substrates (such as exocellular polymers), and microbes contained in the biofilm. Suitable reactions of peroxy compounds of general formula I include addition reactions and abstraction.

The biofilm disrupting activity may be correlated, at least in part, with the O—O bond dissociation energy of the peroxy compound of general formula I.

The bond-dissociation energy (BDE, D₀, or DH°) is one measure of the strength of a chemical bond A-B. It can be defined as the standard enthalpy change when A-B is cleaved by homolysis to give fragments A and B, which are usually radical species. Typical ranges of bond dissociation energies for classes of compounds containing O—O bonds are provided in Table 6 below (Ullman's).

TABLE 6
Bond Dissociation Energy for Selected Chemical Classes

| | O—O Bond Dissociation |
|---|---|
| Chemical Class | Energy kJ · mol⁻¹ |
| Peroxycarboxylic Acids | 80-130 |
| Diacyl peroxides | 120-140 |
| Peroxycarboxylic acid esters | 147-164 |
| Dialkyl peroxides | 170-180 |
| Hydroperoxides | 180-200 |

Examples of bond dissociation energies for a selection of discrete peroxy compounds are displayed in Table 7 below (Yu Ran Luo).

TABLE 7
Bond Dissociation Energy for Selected Discrete Compounds

| | O—O Bond Dissociation |
|---|---|
| Peroxy Compound | Energy kJ · mol⁻¹ |
| methyl hydroperoxide | 189.1 ± 4.2 |
| ethyl hydroperoxide | 178.7 ± 6.3 |
| methaneperoxycarboxylic acid | 169.9 ± 2.1 |
| (HO—OC(O)CH₃) | |
| ethaneperoxycarboxylic acid | 189.1 ± 4.2 |
| (HO—OC(O)CH₂CH₃) | |
| zeroane (HO—OC(O)H) | 199.2 ± 8.4 |
| dimethyl peroxide | 157.3 ± 8.4 |
| diethyl peroxide | 166.1 |
| diacetyl peroxide | 140.2 ± 2.1 |
| (CH₃C(O)O—OC(O)CH₃) | |

Another measure used to provide an indication of the reactivity of a peroxide compound is referred to as active oxygen A[O]. Active oxygen may be calculated from the following formula 1.0:

A[O]_{theoretical} (%)=16×p/m×100 1.0

Where p is the number of peroxide groups in the molecule and m is the molecular mass of the molecule. A higher active oxygen number is indicative of higher activity. The active oxygen will decrease with, for example, increasing chain length. As such, reactivity and stability of peroxy compounds may be influenced by chemical variances such as substitution and chain length.

For example, a general trend that may be inferred by analysis of a range of peroxy carboxylic acid compounds with the above formula 1.0, is that the stability of peroxycarboxylic acid derivatives typically increases with increasing chain length. Conversely, the reactivity would be expected to tend to decrease. For example, peroxyformic acid is less stable than peroxyacetic which is less stable than peroxypropionic acid and so on. Performic acid is, for example, sufficiently unstable that it is frequently prepared directly prior to use. However, increasing chain length leads to decreasing solubility in aqueous environments, such as the environments found within the rising mains of sewerage networks.

Catalase is known to be an important enzyme in protecting the cell from oxidative damage by reactive oxygen species (ROS), such as peroxy compounds of general formula I. Moreover, catalase has one of the highest turn-over of all enzymes. The catalase enzyme is able to protect microorganisms from the oxidative action of hydrogen peroxide.

Catalase enzymes are more typically found in aerobes and facultative microbes and are typically absent from anaerobic microbes. Aerobes, and to some extent facultative microbes, are typically found in more oxygen rich environments such as might be found in the outer regions of biofilm.

Catalase binds, for example, hydroperoxyethane rapidly, but catalysis is very inefficient. The free catalase enzyme takes several minutes to regenerate (Stein, K. G., 1935).

Inactivation of the catalase leads to improvement in the microbiocidal oxidative activity of hydrogen peroxide. Preferably, the biofilm disrupting formulations for use in the present invention comprise a peroxy compound of general formula I and hydrogen peroxide. Preferably, the peroxy compound of general formula I inactivates catalase and peroxidase enzymes.

Suitably, the organic peroxy compounds described in the current disclosure inactivate catalase enzymes by irreversible reaction with the enzyme.

The suitability of a peroxy compound of general formula I for use in the methods of the present disclosure, may be dictated, at least in part, by the physico-chemical properties of the peroxy compound, such as the compound's water solubility. Suitably, the peroxide is sufficiently soluble in aqueous media to effect, in situ, biofilm disruption within systems to be treated, for example sewerage networks.

The peroxy compounds used in the methods and formulations of the present invention should be at least very slightly soluble in aqueous media, preferable at least slightly soluble in aqueous media, more preferably soluble, and even more preferably miscible in aqueous media.

Very slightly soluble materials are those, which have lowered solubility. Usually materials are treated as very slightly soluble if 1 g of material requires 1000 to 10,000 ml of solute to dissolve. Slightly soluble materials are those, which have low solubility. Usually materials are treated as slightly soluble if 1 g of material requires 100 to 1000 ml of solute to dissolve. In other words, a material will be sparingly soluble if the amount which can be dissolved in 100 ml of solute ranges between 0.1 g to 1 g. For example, ethyl hydroperoxide, peroxybenzoic acid, diethyl peroxide and diacetyl peroxide are considered to be slightly soluble in cold water. Materials are usually treated as just soluble (rather than very or slightly soluble) if 1 g of material requires 10 to 30 ml of solute to dissolve. Typically, freely soluble materials are those, which have high solubility. Usually materials are treated as freely soluble if 1 g of material requires 1 to 10 ml of solute to dissolve. In other words, a material will be freely soluble if the amount which can be dissolved in 100 ml of solute ranges between 10 g and 100 g. Very soluble materials are those, which have very high solubility. Usually materials are treated as sparingly soluble if 1 g of material requires 1 ml or less of solute to dissolve. In other words, a material will be very soluble if 1 ml of solvent will dissolve one or more grams of solute. Similarly, miscibility is the property of two substances to mix in all proportions, forming a homogeneous mixture, when added together. For example, peracetic acid is miscible in water in all proportions.

In some embodiments, the peroxycarboxylic acid compound of general formula II is a substituted or unsubstituted water soluble peroxycarboxylic acid. Examples, include performic acid (peroxymethanoic acid), peracetic acid (peroxyethanoic acid), peroxyproprionic acid, peroxybutyric acid (peroxybutanoic acid), perisobutyric acid. peroxyvaleric acid (peroxypentanoic acid) peroxycaproic acid (peroxyhexanoic acid), and the like and derivatives thereof.

Short-chain aliphatic peracids are typically miscible with water while the longer-chain (C6 and higher) are not miscible and demonstrate decreasing solubility with increasing chain length. The degree of solubility of the peroxy compounds used in the methods and formulations of the present invention may be pH dependent.

Substitution of a relatively low molecular weight, for example C₁-C₇ alkyl or aryl, compounds with oxygenated functionalities capable of forming hydrogen bonds, such as carboxylic acids, hydroxyl groups and the like, may tend to an increase in water solubility. Examples of substituted peroxycarboxylic acid compounds include: peroxycitric acid, peroxylactic acid, peroxymalic acid, peroxyglutaric acid, peroxymaleic acid, peroxyoxalic acid, peroxy methoxy acetic acid, peroxytartaric acid, peroxymalonic acid, peroxysuccinic acid, peroxyadipic acid, pyruvic acid, peroxyfumaric acid, persalicyclic acid, percrotonic acid, di-peroxymalonic acid, di-peroxysuccinic acid, di-peroxyglutaric acid, di-peroxyadipic acid and peroxy phthalic acid.

Suitable care should be taken when working with certain compounds of general formula I, suitable for use within the methods of the present invention. Under certain conditions, organic peroxides may be explosive since they contain, for example, both the oxidizer, the O—O bond, and reducing agents, the C—C and C—H bonds. The ignition sensitivity and the violence of deflagration for each type of organic peroxide may decrease in the following order, given the same active oxygen content: diacyl peroxides. peroxyesters. dialkyl peroxides. Hydroperoxides.

Reactivity may also vary within a class, for example, the explosivity of the members of the alkyl monohydroperoxide class decreases with increasing chain length and branching.

Preparation of Organic Peroxy Compounds

Methods for the synthesis of peroxy compounds, for example: organic hydroperoxides (R—O—O—H), dialkyl peroxides (R—O—O—R′), diacyl peroxides (R—C(O)—O—O—C(O)—R′), peroxycarboxylic acids (R—C(O)—O—O—H), peroxycarboxylic acid esters (R—C(O)—O—O—R′) are known (Ullman's).

Peroxoic acids (peroxycarboxylic acids), for example, may be produced by reacting hydrogen peroxide with a carboxylic acid to form quaternary equilibrium mixtures of peroxycarboxylic acid, water, carboxylic acid, and H₂O₂ as reaction products. Concentrations of peroxycarboxylic acid in the equilibrium mixture may be, in the case of for example peracetic acid, up to about 40% of the corresponding peroxycarboxylic acid. This reaction is sometimes referred to as perhydrolysis (Equation 2.0).

R—COOH_{(aq)}+H₂O_{2(aq)}↔R—COOOH_{(aq)}+H2O₍ₗ₎ Equation 2.0

The reaction may be catalysed by the addition of a mineral acid such as sulphuric acid, or other acids such as: ascorbic acid, boric acid or acidic ion-exchange resin. Perform is acid (PFA) synthesis does not necessarily require any additional catalyst, since formic acid can provide an adequate amount of hydrogen ions (formic acid-autocatalyzed synthesis of PFA) Exemplary methods of synthesis of organic peroxy compounds of general formula I are provided.

Exemplary preparation of PFA. PFA is typically generated as a quaternary equilibrium mixture of performic acid (PFA), formic acid (FA), hydrogen peroxide and water. PFA was prepared in two steps. First, 11 mL of formic acid (85% w/w) was mixed with 1.0 mL sulphuric acid (95%) in a glass test tube. Secondly, 0.9 mL of this mixture was added to 1.1 mL of hydrogen peroxide (50% w/w) in a 5 mL test tube, immersed in a water bath controlled at 20° C. The product was allowed to react for 10 min before the product was immediately used for experiments and quantified, in parallel, by dilution (125 μL to 100 ml) of a subsample in demineralized water, to yield a solution of 2 mg.L⁻¹ which was analysed using the method described below for PFA. Performic acid is less stable than for example peracetic acid and may need to be prepared onsite for application.

Exemplary preparation of peracetic acid. In a typical process, water (5.5 kg/h), glacial acetic acid (3.4 kg/h) and hydrogen peroxide (1.8 kg/h of a 25% solution) are mixed in a premix vessel and fed into a still. With a flow rate of 0.02 kg/h, sulfuric acid (20% solution) is added at 115 hPa and 55° C. After a residence time of 0.4 h, the product flow contains 37% peracetic acid, <2% acetic acid, <0.1% hydrogen peroxide, and 61% of water. The product is stabilized with dipicolinic acid and diluted to the desired concentration (Ullman's).

Exemplary preparation of peroxypropionic acid (PPA). For the preparation of PPA employ a molar ratio of H₂O₂ to propionic acid of more than 3.5:1, temperature up to 60° C., a H₂O₂ to water ratio up to 0.8, and a catalyst (such as H₂SO₄). (Leveneur, S. et al, 2008, U.S. Pat. No. 4,087,454).

Methods for the preparation of alkylhydroperoxides are known, for example: the preparation of dialkylperoxides in particular diethyl peroxide (Nangia, P, & Benson, S. W., 1962), the preparation of alkyl hydroperoxides, (Williams, H. R., & Mosher, H. S., 1954a), and secondary alkyl hydroperoxides Williams, H. R., & Mosher, H. S., 1954b)

Biofilm activity may vary along the length of a rising main and as such should be taken into account when considering biofilm management. Accordingly, in some embodiments, the biofilm disrupting formulation comprises peroxy compounds of general formula I selected for their physico-chemical properties such that, multiple organic peroxy compounds of general formula I may be combined to provide differing reactivities, for example, a high reactivity, a medium reactivity and lower activity. For example, after the administering of a dosage of a biofilm disrupting agent comprising a formulation containing a mixture of peroxycarboxylic acids to a wet well, followed by subsequent pumping of the dosage from the wet well into the downstream rising main, higher reactivity organic peroxy compounds of general formula I, such as for example, peracetic acid, will react more rapidly and closer to the junction of the wet well with the rising main, whilst less reactive peroxy compounds of general formula I, for example, C₃-C₈ peroxycarboxylic acids, will travel further along the rising main before being consumed.

Other physico-chemical properties may also differ. In some embodiments, a formulation may comprise at least one hydrophilic agent and at least one hydrophobic agent taking advantage of different mechanisms of deliver into the biofilm.

Therefore, in some embodiments, a dosage formulation may be multifunctional containing two or more organic peroxy compounds of general formula I.

Biofilm disrupting agents comprising formulations containing mixtures of peroxycarboxylic acids may be manufactured using combinations of two or more peroxycarboxylic acids and hydrogen peroxide according to Equation 3.0 below.

R¹—COOH+R²—COOH+ . . . . . . +Rⁿ—COOH+H₂O₂↔R¹—COOOH+R²—COOOH+ . . . + . . . Rⁿ—COOOH+H₂O 3.0

An exemplary mixture according to the current disclosure is a mixture of acetic acid, hydrogen peroxide, octanoic acid and water. A further exemplary mixture according to the current disclosure is a mixture of peroxyacetic, butanoic acid, hydrogen peroxide and water. Suitably, after initial mixing, the mixtures may be left for a period about of 3-10 days to form equilibrium mixtures.

Alternatively, organic peroxy compounds according to general formula I may be prepared separately and then combined. Optionally, the separately prepared peroxy compounds may be combined prior to administration or upon administration to the location to be dosed in the wastewater system. For example, solution 1 containing an equilibrium mixture of peracetic acid, acetic acid, hydrogen peroxide and water may be mixed in a 1:1 volumetric ratio with a solution of an equilibrium mixture of peroxybutanoic acid, butanoic acid, hydrogen peroxide and water with the resulting formulation administered to the wastewater system. Alternatively, a first solution containing an equilibrium mixture of peracetic acid, acetic acid, hydrogen peroxide and water and a second solution containing an equilibrium mixture of peroxybutanoic acid, butanoic acid, hydrogen peroxide and water may be separately pumped into a stream of water being pumped into, for example, into a wet well, as a biofilm disrupting dosage.

Preferred features, embodiments and variations of the invention may be discerned from the following Examples which provides sufficient information for those skilled in the art to perform the invention. The following Examples are not to be regarded as limiting the scope of the preceding Summary of the Invention in any way.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

Any embodiment of the invention is meant to be illustrative only and is not meant to be limiting to the invention. Therefore, it should be appreciated that various other changes and modifications can be made to any embodiment described without departing from the spirit and scope of the invention.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### EXAMPLES

When considering application of the methods and formulations of the present disclosure, one or more of the following indicators of a sewerage network problem may be taken into account:
1. Intelligence from the sewerage network operator (for example, utility or council) that the existing odour control strategy is unable to sufficiently control odour emanation from the sewerage network, for example, increasing the dosing levels of the current H₂S amelioration chemistry does not have a consequential and proportionate reduction in odour, either measured as H₂S or advised by location confirmation;
2. H₂S monitoring indicates there should be very little H₂S present and yet there are still problems with malodorous emissions from the sewerage network;
3. An increase required in odour control reagent dosing to maintain existing levels of H₂S. This could result, for example, from increased SRB activity within the network from one or more of factors such as: pH changes within the network, increasing network temperature (e.g. winter to summer); changes to nutrient levels within the network and changes to effluent composition. Whatever the cause may be, increasing the dosage rate of the H₂S control agent leads to increasing costs and in any event may be largely effective as such a dosage strategy does not address the root cause, where the cause of the malodour is, for example mercaptan in origin; and
4. When testing indicates the presence of mercaptans within, or the emission of mercaptans from the network. The malodorous emission of mercaptans is typically less likely to be influenced by standard odour control strategies and have an odour threshold of only 2 ppb.

Exemplary Dosing Method 1

For the present example, the peracetic acid formulation contains the following components in the following proportions (w/w %) (15% peroxyacetic acid: 10% H₂O₂: 30%-40% Acetic acid: balance H₂O). Following a typical dosing strategy, the dose quantity of the peracetic acid formulation is calculated as 0.3% of the wet well cycle volume.

Step 1

The sewerage pump station (SPS) pump, upstream of the wet well to be dosed, is temporarily suspended via contact with the sewerage network control room.

An appropriate quantity of fresh or recycled water, for example about 20% of the cycle volume, is delivered or pumped to the wet well from, for example: a road tanker, a high-volume standpipe connected to a mains water line, or recycle water line (if available). Many wet wells but not all are fitted with recycled water flushing systems where this water type and addition method could be used. The quantity of fresh or recycled water to be added to the wet well is about 15%-50% of the wet well cycle volume and preferably about 20%-30% of the wet well cycle volume. This quantity of fresh or recycled water is the flush water. Suitably, the flush water is delivered rapidly to the wet well to minimise disruption to the network. During the addition of fresh water to the wet well, the continued flow of a portion of the gravity feed of raw sewer into the wet well may be largely unavoidable and accordingly a small amount (up to about 20% of the target water addition volume) of fresh sewer may arrive at the wet well. Given this is relatively small addition of sewer water, and in the interest of maintaining a continuous sewer flow without interruption to consumers, it is preferable to leave gravity flows to the wet well open when implementing the dosing method. Similarly, and to minimise interruption, the preferred time of day for implementing the dosing process is in the low flow periods usually between midnight and 0500. Pumping of the newly added water from the wet well into the rising main is commenced, for example, by manual actuation of the pump or via contact with the control room, and the added volume of water is pumped into the rising main.

Step 2

After the first portion of flush water has been pumped into the rising main, a further portion of fresh or recycled water, in a quantity of about 15%-50%, preferably about 20-30%, of the wet well cycle volume, is subsequently pumped into the wet well. During addition of the water, a mineral acid such as hydrochloric acid is added to the wet-well, or mixed into the pumped stream of water, so as to reduce the pH of the final volume of the second portion of water to a pH of about 5-7.5, preferably to a pH of about 6-7. Considering that source (fresh or recycled) water pH can vary, it may be prudent to evaluate the minimum acid dose required to achieve the target pH. Once the second portion of water has been added, and the target pH target reached, a pre-determined volume of peracetic acid formulation, is added from an IBC directly into the acidified wet well water. The volume to be added is calculated based on 0.3% v/v of the original wet well cycle volume taking care not to exceed 5% v/v concentration of peracetic acid formulation in the acidified water. This results in a peracetic acid concentration of about 6 mmol/L. If a formulation containing a higher concentration of peracetic acid is to be used, for example, a formulation (F2) containing in the following proportions (w/w %): 25% peroxyacetic acid: 5% H₂O₂: 45% Acetic acid: balance H₂O, then the volume of formulation to be added would be adjusted to achieve approximately 6 mmol/L of peracetic acid. In the case of F2 this would result in the addition of about 0.18% v/v of the original wet well cycle volume of F2. It may be desirable to use other formulations. For example, if reducing dissolved H₂S is appropriate then a formulation such as F3 containing in the following proportions (w/w %): 15% peroxyacetic acid: 23% H₂O₂: 10% Acetic acid: balance H₂O, may be used, taking advantage of the higher proportion of hydrogen peroxide in the formulation. Care should also taken during addition to avoid contact with any infrastructure in the wet well using a stainless-steel dip pipe to deliver the formulation directly to the water surface with reduced splashing. Once the organic peroxy compound has been added, the wet well pump can be re-actuated and the dose fluid pumped from the wet well into the rising main until the wet well is substantially or nearly empty.

Step 3

Repeat steps 1 and 2 until such time as an equivalent of about 5-30%, preferably about 10-20% of the rising main volume has been filled with successive portions of flush water and dose fluid.

During implementation of the process, the time frame and volume of sewer being collected in the upstream SPS may need to be considered. This can be managed with positive communication with the control room. Moreover, the time of day the treatment is conducted may determine how quickly the upstream wet well will fill and therefore how long a treatment process can be considered viable.

Once satisfied that the above conditions are met, temporary suspension on the upstream SPS can be removed and the network allowed to push the successive portions of flush water and dose fluid, together forming a dosage, through the rising main to the next SPS.

In consideration of the fact that the upstream receiving SPS now has a larger than usual collection of water, the pump out rate from the treated wet well is intermittently pumped to ensure the treatment slug of water has as much contact time with the rising main as is allowed to maintain functioning levels in SPS within that section of the network. The time frame for operating the pump, should consider moving the length equivalent of the volume of the treatment portion and holding it in that position for 5-30 mins, preferably 10-20 mins.

Monitor the receiving manhole for residual organic peroxy compound levels, ORP and observe the disrupted biofilm exiting the rising main, for example, as finely dispersed black particles in the sewer water.

As the dosage fluid reaches the receiving manhole the pH of the dosage fluid should be raised with a pH modifier such as magnesium hydroxide slurry to achieve a pH of about 8.2-8.5. This is important so as to avoid the possibility of degassing of H₂S from downstream of the receiving main, such as in connected gravity mains.

Exemplary Dosing Method 2

An alternative to Exemplary Dosing Method 1, as described above, is to instead of acidifying the dose fluid, to allow the pH of the sewage in the sewerage network, at the location to be dosed, to naturally lower to about pH 7. The same procedure as above is then applied with the exception that the dose fluid is not acidified.

H₂S emissions should be monitored during implementation of Exemplary Dosing Methods 1 and 2.

Exemplary Dosing Method 3

Dosing a gravity main. Open receiving manhole and assess flow rate based on SPS pump flow rate and continuously dose into the flow a biofilm disrupting formulation at a rate to generate a concentration of active agent within the flow of about 6 mmol/L. For gravity mains, there are no wet-wells to charge into, so continuous dosing to match the desired concentration is required while the sewer is flowing. Since the sewer flows in pump cycles, the flow is closely observed and dosed directly into the wastewater stream accordingly, during the flow cycles. For example, with an SPS pump flow rate of 100 L/s, and dosing with the following formulation: 15% w/w peracetic acid; 10% w/w hydrogen peroxide; 30%-40% w/w acetic acid, and the balance water, then the formulation dose rate is 0.3 L/s or 18 L/min for the 2-3 minutes that the pump runs. Wait for the next pump-out cycle, then dose again. Optionally, low COD acidified fresh or recycled water may be added upstream, pumped from the SPS and dosed as it arrives at the receiving manhole (tested as increase in ORP level alongside hydraulic calculations for HRT).

Trial 1

The aim of trial 1 was to develop a method for controlling the activity anaerobic microbes including sulphate reducing microbes and methanogenic archaea by disrupting biofilm in a sewerage network environment containing such organisms by treating the environment with a formulation (Formulation 1—see below) of peracetic acid (PAA). Effective control of SRB and methanogens can be inferred through the reduction of hydrogen sulphide (H₂S) gas detected in sewers. A successful trial would consider the following key outcomes:
1. A significant reduction in H₂S at a sewage pump station (SPS) and downstream from that SPS.
2. A slow return (more than 2 weeks) of H₂S after achieving the above outcome and then ceasing to dose the peracetic acid formulation.
3. Maintaining H₂S levels within target (<20 ppm H₂S gas phase) with lower doses of PAA.

The location selected to operate this trial (Location 1) was selected because it was currently delivering unacceptable levels of community odour complaints and had significant levels (800-1,000 ppm) of H₂S being reported, even with existing odour control strategies currently in place—magnesium hydroxide liquid (MHL). In the case of location 1, the existing MHL dosing equipment was replaced with a PAA dosing station. The idea of PAA (as a powerful oxidizing biocide) is to conduct the initial dosing as a “kill dose” at higher rates over a period of time then reduce dose rate back to a minimum to control H₂S that comes through from other sources. The further idea of lower dose rate PAA is to simply control the total H₂S levels by reacting with the lower levels of H₂S produced in the test section of sewer main and control the growth rate of SRB.

The results displayed in Table 4 are directly reported from H₂S Odalogs. The loggers were calibrated monthly and exchanged weekly to ensure the integrity of the data could be maintained.

Note that in Table 4 below, ppm references for dosing refers to the actual dose of the product as used per unit volume in the wet well. The product consumption was determined by the size of the wet well volume and how often it cycled. The higher the sewer flow rates, the more often the wet well emptied but the ppm of product remained constant. The Formulation 1 (F1) used in the trial was 15% w/w peracetic acid; 10% w/w hydrogen peroxide; 30%-40% w/w acetic acid, and the balance water. Magnesium hydroxide liquid (MHL) is a slurry of magnesium hydroxide in water comprising 34% by weight Mg(OH)₂.

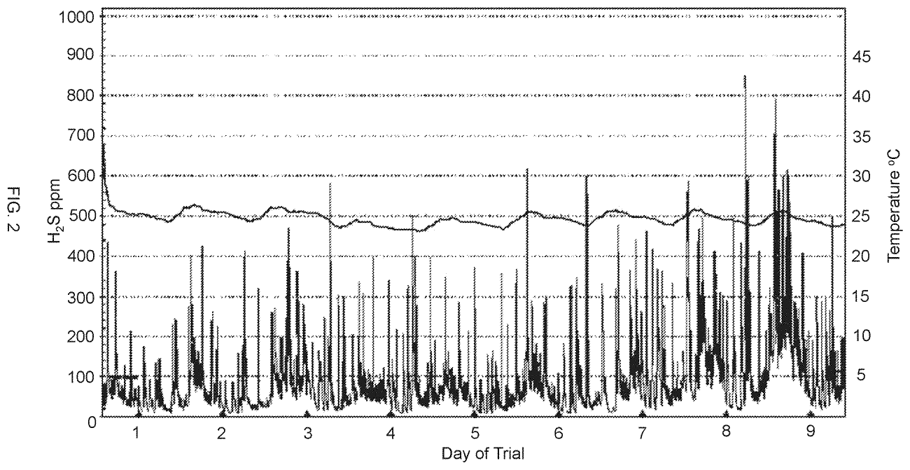

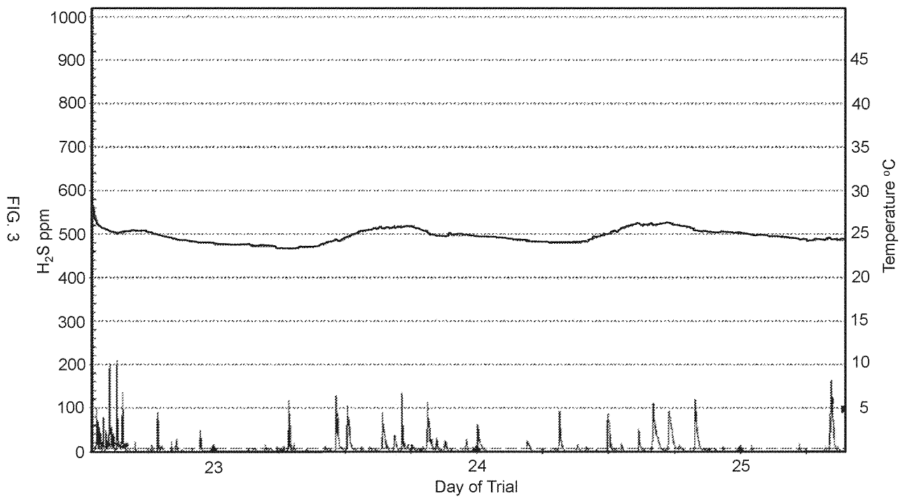

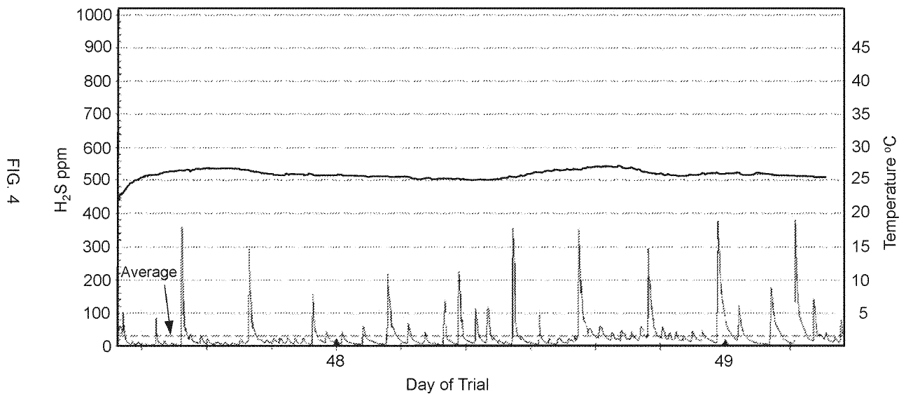

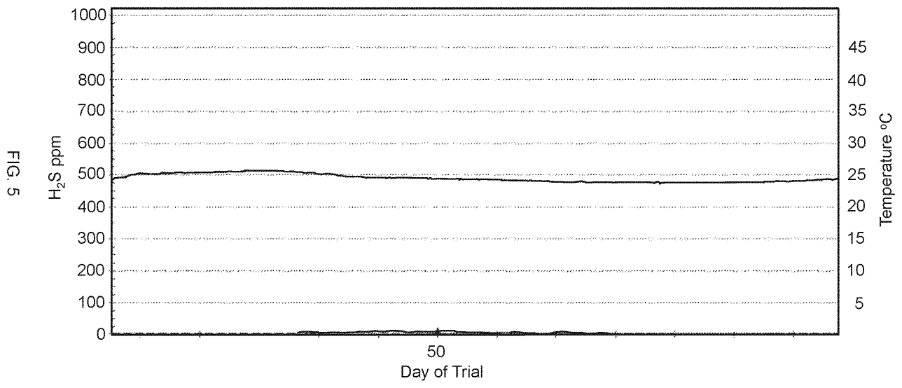

TABLE 4
Results Trial 1

| | Dose Rate | | | |
|---|---|---|---|---|
| | (F1 as | Avg. | Peak | |
| Days | used, mg/L) | H₂S | H₂S | Comment |
| 1-9 | 0 | 89 | 854 | Whilst the average H₂S is within the target limits of <5 |
| | | | | ppm, the odour complaints from Location 1 and near the |
| | | | | test manhole are reflected in the high peak readings |
| | | | | coincidental with the pump start flows from Location 1. |
| | | | | Peak readings are beyond the target of <20 ppm. (See |
| | | | | FIG. 1) |
| 10-16 | 33 | 166 | 837 | The dose rate at 33 ppm of F1 was insufficient for this |
| | | | | specific environment. Whilst this dose rate may be |
| | | | | appropriate for waste-water disinfection, the rate did not |
| | | | | factor the significant amount of H₂S and COD that |
| | | | | already existed in the network at this location. |
| 17-21 | 600 | 151 | 1080 | Even with this significantly increased dose rate, the H₂S |
| | | | | readings were both significant and increasing. It was |
| | | | | determined that there was a significant base load |
| | | | | production of bacteria producing a large quantity of H₂S |
| | | | | and until the H₂S is consumed, the bacteria would not |
| | | | | be killed. |
| | | | | A significantly higher “kill dose” of F1 would be required |
| | | | | to overcome the H₂S levels and the build-up of bacteria |
| | | | | in what was likely to be a thick biofilm layer. This was, |
| | | | | perhaps, not unexpected but the exact concentration |
| | | | | required to reach this critical tipping point was unknown. |
| 22-25 | 3,300 | 7 | 211 | The F1 dose rate was able to cut through the |
| | | | | background H₂S levels and be available to start working |
| | | | | on killing the bacteria residing in the biofilm. (See FIG. 2) |
| | | | | The continuation of high H₂S peak recordings coincides |
| | | | | with pump times which highlight the possibility still exists |
| | | | | to vaporise H₂S into the sewer head space with |
| | | | | aspirated volumes of sewer. |
| | | | | However, it is a significant sign that shows it is possible |
| | | | | to significantly drop the H₂S levels overall. Given the |
| | | | | five-fold jump in dose rate, there is scope to fine tune |
| | | | | dosage to optimise the ongoing suitability of this |
| | | | | product's capability. |
| | | | | Downstream testing of sewer water peroxygen levels at |
| | | | | the test manhole, confirmed that with 50 ppm of |
| | | | | hydrogen peroxide still available, no peracetic acid |
| | | | | detected, the dose rate was not significantly higher than |
| | | | | what was initially required to overcome the base load of |
| | | | | H₂S in the system. Confirm this by reducing F1 dosage |
| | | | | to half this level and look for bounce back effect. |
| 26-30 | 1680 | 20 | 243 | Halving the F1 dose rate from the previous trial |
| | | | | increased the average and peak H₂S levels. |
| | | | | This result demonstrates that it may take time at higher |
| | | | | dose rates (depending on biofilm thickness) to |
| | | | | completely gain access to and kill microbes living in the |
| | | | | biofilm. |
| | | | | The higher average H₂S reading was a direct result of a |
| | | | | change to the sewer flow such that it became aspirated |
| | | | | compared to the previous reading. |
| 31-42 | 0 | 76 | 642 | The F1 dose rate was set to zero to determine how long |
| | | | | it takes for the H₂S to recover back to pre-dosing H₂S |
| | | | | levels. The overall time frame was 14 days to increase |
| | | | | from an average of 7 ppm to 76 ppm H₂S. |
| 43-49 | 670 | 47 | 492 | Commencing re-dosing saw an immediate reduction in |
| | | | | overall H₂S results but still had peak flow excursions |
| | | | | over 400 ppm. This suggests either external inputs of |
| | | | | H₂S or some other influence that is affected by pumping. |
| | | | | (see FIG. 3) Clear link between pump cycle and H₂S |
| | | | | evolution with a consistent tailing of H₂S indicating a |
| | | | | natural decay or dilution of gas while the pump cycle has |
| | | | | stopped. This does not support the idea that H₂S is |
| | | | | being generated in the pipe but rather the H₂S is being |
| | | | | “let go” from the sewer water. |
| 50 | 1340 | 0.7 | 2.5 | Odalog testing at the next wet-well (Location 1a) that |
| | | | | the Location 1 pump pumps into, confirmed the |
| | | | | behaviour of the F1 is in fact reducing the H₂S levels. |
| | | | | This was clear evidence that something had changed in |
| | | | | between Location 1 and Location 1a. (See FIG. 4). |
| | | | | Inspection of the receiving manhole revealed that there |
| | | | | was a build-up of sewer waste solids on a cut-out on the |
| | | | | outside bend of the downpipe into the gravity main. |
| | | | | Every time the pump started from Location 1, sewer |
| | | | | water was aspirated into the manhole and released a |
| | | | | significant discharge of H₂S that should have been |
| | | | | otherwise solubilised in the water. This cut-out was |
| | | | | introduced by the water utility after a blockage in that |
| | | | | down pipe and explains the high peak readings on pump |
| | | | | starts. |
| 51-90 | 270 | 2.6 | 48 | F1 dosing regularly shows an extremely well controlled |
| | | | | odour managed system. The excursions with H₂S |
| | | | | readings above 5 ppm are always at the same time of |
| | | | | the day and always in early hours of the morning. These |
| | | | | results do highlight however a possible opportunity to |
| | | | | have timed dosing during such regular events. The most |
| | | | | likely source of input was identified as an industrial |
| | | | | waste discharge (prawn trawlers returning from sea and |
| | | | | discharging bilge water) at the same time most days. |
| | | | | (See FIG. 5) |
| | | | | Ongoing dosing of F1 at this rate produced consistently |
| | | | | excellent H₂S results. |

Conclusion:

From this trial the following concepts and processes can be used as a starting point for future peracetic acid formulation odour control strategies. In this trial:
an initial kill dose rate was required to have a sudden, shocking and significant impact on resident populations of microbes in the sewer and biofilm removal.
the kill dose was found to be effective at 2,000 ppm or 0.2% of a wet well volume or 2 litres of Formulation 1 (F1) (15%)/1,000 litres.
it was found that the initial dose rate should be maintained for a minimum of 3 days to penetrate biofilm layers in previously untreated sections of sewer.
after the 3-day initial kill dose rate, F1 dose rates were then reduced to a minimum of 500 ppm where they were maintained at this level.

Trial 2

The aim of Trial 2 was to develop a method for controlling the activity anaerobic microbes including sulphate reducing microbes and methanogenic archaea by disrupting biofilm in a sewerage network environment containing such organisms by treating the environment with a formulation (Formulation 1 as was used in Trial 1 above) of peracetic acid (PAA). Effective control of SRB and methanogens can be inferred through the reduction of hydrogen sulphide (H₂S) gas detected in sewers. A successful trial would consider the following key outcomes:
1. A significant reduction in H₂S at a sewage pump station (SPS) and downstream from that SPS.
2. A slow return (more than 2 weeks) of H₂S after achieving the above outcome and then ceasing to dose the peracetic acid formulation.
3. Maintaining H₂S levels within target (<20 ppm H₂S gas phase) with lower doses of PAA.

The site selected (Location 2—sewage pump station including wet well) to operate this trial has the following characteristics:
a. Pump out volume=950 L
b. The pump station feeds into the head of the syphon at a manhole 200 m further downstream where H₂S monitoring is conducted.
c. The site was chosen because of numerous community odour complaints from this location and further downstream at the next closest manhole, where significant levels (>600 ppm) of H₂S had been reported. There was no existing odour control technique in place at location 2 or along the syphon.

In this trial, a new 20′ multi-chemical dosing station was delivered to site and installed with dosing directly into Location 2. This dosing station enabled the handling of Formulation 1, hydrogen peroxide and MHL at various stages of the trial without the need to bring in new equipment. The hydrogen peroxide solution used was a 50% wt aqueous solution.

The peracetic acid in Formulation 1 performs the initial dosing as a “kill dose” at a high rate over a period of time. The dose rate is then reduced to control H₂S that comes through from other sources or alternate H₂S sequestering technologies used (hydrogen peroxide and MHL).

The purpose of hydrogen peroxide (a bacteriostatic agent) is to simply control the total H₂S levels by oxidizing the H₂S produced (or coming from upstream) and slowing the growth rate of SRB. The inclusion of hydrogen peroxide and MHL in this trial is to determine which solution is more effective when combined with Peracetic acid treatment.

Results

The following results are directly reported from H₂S Odalogs located in a manhole, 200 m from the injection point at Location 2. The loggers were calibrated monthly and exchanged weekly to ensure the integrity of the data could be maintained.

Note that ppm references for dosing refers to the actual dose of the Formulation 1 product as used per unit volume in the wet well. The Formulation 1 consumption was determined by the size of the wet well volume and how often it cycled. The higher the sewer flow rates, the more often the wet well emptied but the ppm of Formulation 1 remained constant.

The table below (Table 5) shows resultant H₂S at each Formulation 1 dose rate and the period of time kept at that dose rate.

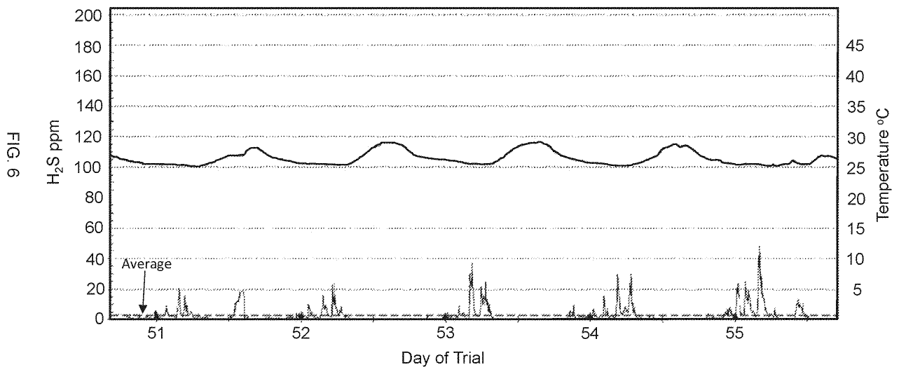

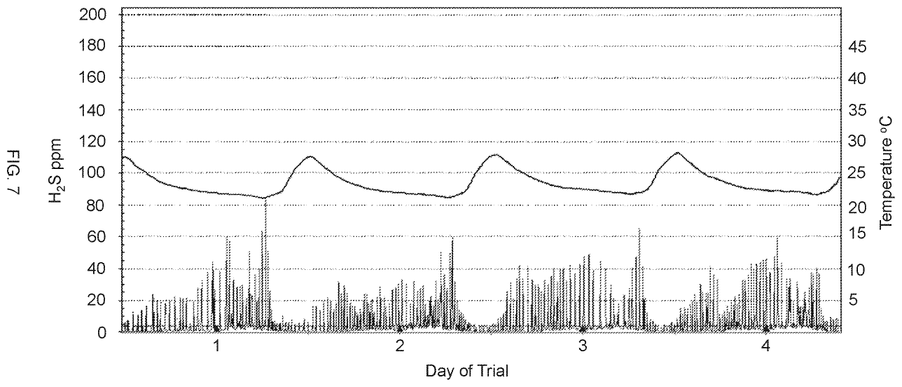

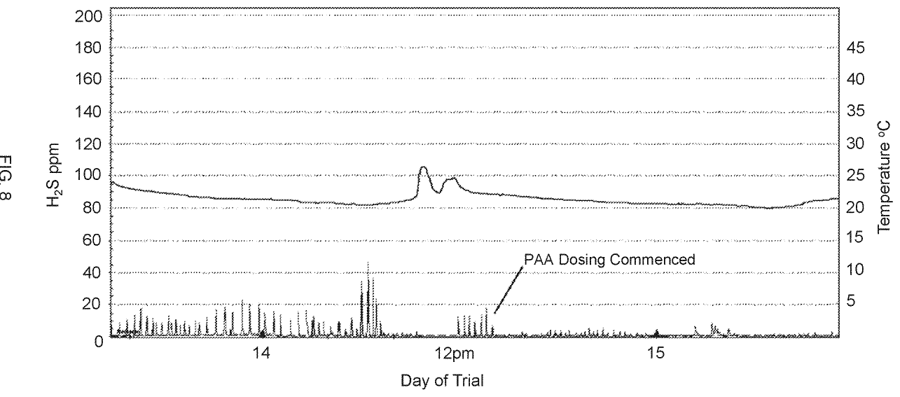

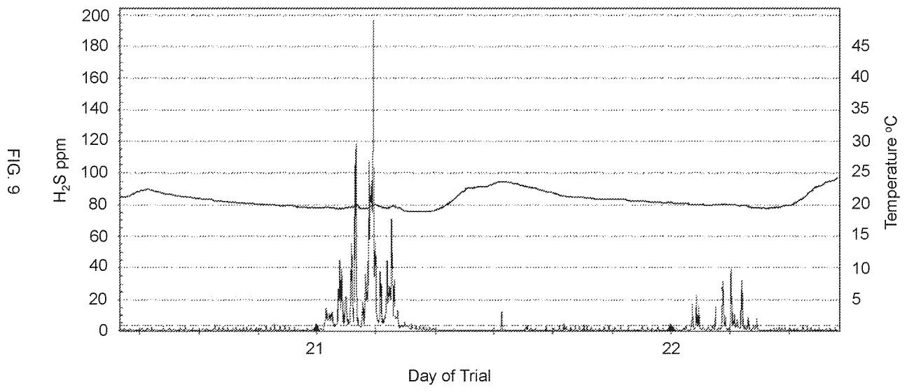

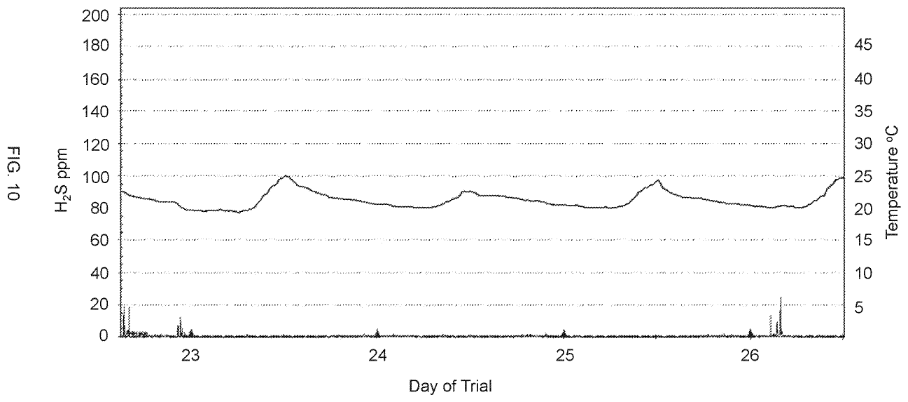

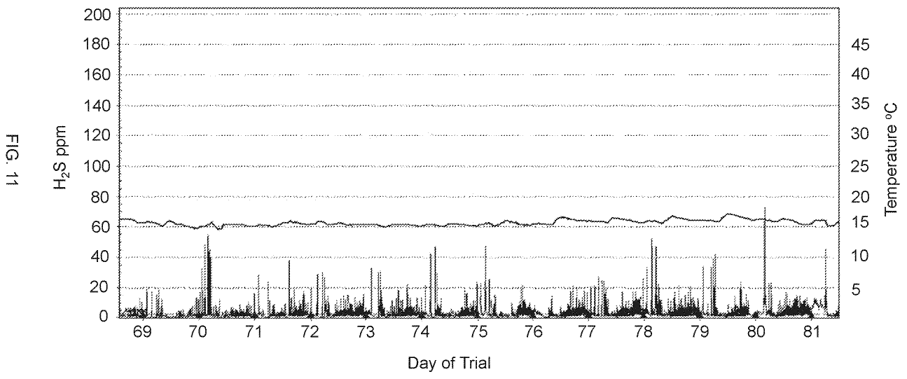

TABLE 5
Results Trial 2

| | Dose Rate | | | |
|---|---|---|---|---|
| | (Chemical | Avg. | Peak | |
| Days | as used, mg/L) | H₂S | H₂S | Comment |
| 1-4 | 0 | 3.8 | 85 | Whilst the average H₂S is within the target limits of <5 |
| | | | | ppm, the odour complaints from Location 2 and near the |
| | | | | test manhole are reflected in the high peak readings |
| | | | | coincidental with the pump start flows from Location 2. |
| | | | | Peak readings are beyond the target of <20 ppm set. |
| | | | | (See FIG. 6) |
| 5 | 2,000 | 4.0 | 85 | PAA was added to the head of the syphon, upstream of |
| | (F1) | | | Location 2. There was no change to the H₂S levels by |
| | | | | dosing in this location. This result reflects the |
| | | | | observation previously that the results follow the pump |
| | | | | cycles from Location 2 quite consistently and treating |
| | | | | the syphon will have minimal impact on what is coming |
| | | | | into the manhole from Location 2. Recommend dosing |
| | | | | directly into Location 2. |
| 6-13 | 0 | 2.4 | 83.5 | Similar results to days 1-4 baseline data but showed a |
| | | | | clear relationship between Location 2 pump out and H₂S |
| | | | | spikes. |
| 14-17 | 2,000 | 0.9 | 6.0 | Formulation 1 dosed directly into Location 2. |
| | (F1) | | | Reductions in both peak and average H₂S were very |
| | | | | fast. Within 90 minutes of dosing commencing, peaks |
| | | | | had reduced significantly, and the average was now |
| | | | | less than 1 ppm. (FIG. 7) |
| 18-20 | 1,000 | 0.8 | 40 | Halving the Formulation 1 dose rate from the initial kill |
| | (F1) | | | dose had only a minor impact on the average H₂S levels |
| | | | | which indicated that there was still the ability of the trial |
| | | | | section of pipe to produce H₂S or that the incoming H₂S |
| | | | | from upstream of Location 2 or the syphon H₂S is now |
| | | | | not being fully reacted. This is an important result |
| | | | | because it demonstrates that it may take time at higher |
| | | | | dose rates, depending on biofilm thickness, to |
| | | | | completely gain access to and kill microbes that are |
| | | | | living in the biofilm. |
| 21-22 | 500 | 3.3 | 197 | The average result over this period would have been |
| | (F1) | | | significantly better if not for the peaks between 1 am and |
| | | | | 6 am on both days. This suggests incoming H₂S not |
| | | | | produced H₂S in this treated pipe section coinciding with |
| | | | | upstream septic tank releases at the same time each |
| | | | | day. Scheduled dosing from 0100-0300 at 2,000 ppm |
| | | | | was initiated. (FIG. 8) |
| 23-27 | 500 & | 0.3 | 25.6 | No large peak H₂S, average back in control again. |
| | (2,000 | | | Continue to monitor at this dose rate. (FIG. 9) |
| | from 0100- | | | |
| | 0300) (F1) | | | |
| 28-66 | 500 & | 1.1 | 42 | Results tracking consistently with no major change in |
| | (2,000 | | | peak results on Location 2 pump starts. |
| | from 0100- | | | |
| | 0300) (F1) | | | |
| 67-68 | 330 | 0.3 | 3 | Formulation 1 dosing stopped and hydrogen peroxide |
| | (H₂O₂) | | | dosing commenced. This showed in immediate |
| | | | | reduction in H₂S peaks. Considering that there was 2 |
| | | | | times more active oxidiser in the grade of hydrogen |
| | | | | peroxide compared to the Formulation 1 grade, this |
| | | | | result demonstrates that the H₂S is no longer being |
| | | | | produced in this section and is consumed readily by the |
| | | | | hydrogen peroxide. |
| 69-81 | 330 | 2.8 | 72 | H₂S virtually returning to pre-Formulation 1 trial levels. |
| | (H₂O₂) | | | This suggests SRM populations are coming back and |
| | | | | the peroxide is having to oxidise an ever-increasing |
| | | | | amount of H₂S once again. (FIG. 10) |
| 82-86 | 1,000 | 3.7 | 33 | The pump-out rate is significantly reduced between |
| | (H₂O₂) | | | midnight and 0600 which accounts for the majority of the |
| | | | | higher peaks. This makes sense because in this |
| | | | | domestic collection system, most people are asleep, |
| | | | | and the sewer flows drop significantly. Hence, even if |
| | | | | dose levels are increased at Location 2, this is not |
| | | | | getting to the syphon where H₂S levels are building up |
| | | | | during the night. It is therefore unnecessary to maintain |
| | | | | high levels of peroxide addition on an ongoing basis |
| | | | | when 330 ppm can deliver the same result. |
| 87-Ongoing | 500 | 0.9 | 12 | MHL had an instantaneous and significant impact on |
| | (MHL) | | | H₂S recorded values from the day after it was |
| | | | | introduced. (See FIG. 11) |
| | | | | MHL has continued to be dosed at Location 2 with the |
| | | | | view that the next PAA kill dose cycle would be |
| | | | | implemented only when the H₂S data demonstrates that |
| | | | | a higher dose of MHL is required to achieve the same |
| | | | | outstanding levels of H₂S control. Up to 24 months later, |
| | | | | no such excursions or uncontrolled readings of H₂S |
| | | | | have been identified. The dose rate of MHL is higher |
| | | | | than ordinarily used (200 ppm) to cater for raising the |
| | | | | pH in the syphon volume as well. |

Conclusion:

The trial demonstrates that effective control of H₂S can be achieved through a two-step process:
1. Treatment of a sewer section with Formulation 1, immediately reduces the population of microbes in the first instance. For this trial Location, Formulation 1 treatment (“Kill dose”) at 2,000 ppm (v/v as supplied) should continue for a minimum of 3 days.
2. Ongoing management of H₂S is then successfully achieved with MHL at 500 ppm (v/v as supplied) and dosed continuously. After 24 months there had been no significant return of high H₂S levels and no odour complaints.

The inlet pipe to the manhole should be modified with a down pipe such that it doesn't spray into the manhole every time the pump starts.

As a matter of course for preventative management of H₂S and reduction in MHL or any odour control chemical requirements, addition of Formulation 1 at least every 6 months is recommended to assist with sewer pipe and wet-well microbe population reduction.

The trial has further demonstrated it is possible to use only Formulation 1 or less efficiently, hydrogen peroxide, for ongoing maintenance and odour control at 500 ppm dose rates. However, the most efficient process, is to use MHL for maintenance dosing after an initial kill dose with Formulation 1, for 3 days at 2,000 ppm. Further trials recommended to determine if shorter periods of Formulation 1 treatment would achieve the same outcome.

Trial 3

Magnesium hydroxide liquid (MHL) had been dosed at a Sewer Pump Station 1 (Location 3a), for 1 month prior to the commencement of this trial, with continuous monitoring of H₂S. Results showed a significant reduction in H₂S at the combined receiving manhole from sewer pump station 1 (Location 3a), sewer pump station 2 (Location 3b) and sewer pump station 3 (Location 3b) from over 200 ppm to averages less than 10 ppm and spikes to 50 ppm. Whilst these reductions demonstrated the positive benefits of using MHL alone, it did not reduce the H₂S completely and there were still significant odours emanating from that receiving manhole.

Formulation 1 was used to treat Location 3a and remove potential sources of odour causing chemicals and the microbes that produce them. Further, by isolating Location 3a from the other input sources at the receiving manhole, the trial demonstrated the advantages of using a combined method of peracetic acid oxidation with MHL dosing to deliver a long term sustainable odour and corrosion control solution that could be applied to other pump stations in the network.

The setup in this trial section of sewer included: Location 3a with a 5.7 KL pump-out volume per cycle;
Each cycle was pumped out over ˜2 mins.
Filling time during the period of the trial (10:30-14:30) was ˜15 mins to high level pump cut-in.
Rising main coming from Location 3a was 4.5 km long of 250 mm diameter pipe.
The receiving manhole is also home to 2 other rising main outlets from Location 3b and Location 3c.
Formulation 1 was manually dosed through a stainless-steel dip pipe into the incoming waste water stream at the desired dose rate at Location 3A.

Using Formulation 1 in Combination with MHL

Mercaptans, which have a distinct “rotten cabbage” like odour, are often masked or even mistaken as H₂S, however, they are not solublised by increasing pH, nor can they be precipitated by ferrous chloride.

The only method available to remove these toxic odours with odour thresholds <2 ppb, is to initially oxidatively destroy them and finally kill the microbes that produce them by dosing with peracetic acid, then stopping the regrowth of microbes including bacteria and archaea by maintaining continuous MHL dosing.

The benefit of using MHL in conjunction with PAA is that the high pH reduces enzyme activity and inhibits the formation of the Extracellular Polysaccharides (EPS) that weakens the bio-matrix that SRMs and other odour causing microbes thrive inside. Therefore, combinations of MHL and PAA work efficiently together. A Formulation 1 kill dose at rate of 3,000 ppm will non-selectively kill microbes including SRMs, methanogenic archaea and other bacteria that produce H₂S, methane and mercaptans respectively. In the first instance, on initial dosing of the formulation, peracetic acid reacts with free H₂S, mercaptan and other oxidizable organics and COD. Once removed, the remaining PAA is then available to start acting on the biofilm and the bacteria that live within it.

Trial Aim

The intention of this trial was to:
1. Determine and confirm the cause of the residual odour from Location 3a (thought to be mercaptan related).
2. Validate the H₂S readings from Location 3a by stopping pump cycles from the other two rising mains coming from Location 3b and Location 3c and prove that residual H₂S is coming from untreated lines and not Location 3a.
3. Dose Formulation 1 into Location 3a for the purpose of demonstrating the immediate effect of reducing both mercaptan and H₂S.
4. Continue tracking daily performance by monitoring H₂S from Location 3a post Formulation 1 kill dose trial with continuous MHL dosing. The aim was to reduce MHL dose rates once production of mercaptans and H₂S was significantly reduced.
5. Validate the significant performance improvements in odour causing chemicals and optimise dose rates of MHL to pave the way to show what could be achieved through treatment of Location 3b, Location 3c and other rising mains in the network similarly.

Application Methodology:
4. The following calculations were made to determine the volume of each pump cycle at Location 3a and subsequent Formulation 1 dose rate at 3,000 ppm target:
   a. Well diameter—3.8 m
   b. Cut-in height—7% (=0.7 m being % of 10 m range)
   c. Cut-out height—2% (=0.2 m being % of 10 m range)
   d. Pump Cycle volume=3.142×1.9²×(0.7-0.2)=5.7 KL
   e. Formulation 1 dose rate=3,000 ppm×5,700 L=17 L PAA/cycle.
5. Prior to any Formulation 1 dosing, H₂S and mercaptan levels were recorded with Location 3b and Location 3b pumps switched off.
6. During one of the Location 3a pump cycles, H₂S, mercaptan, pH and alkalinity levels were instantaneously recorded at the start of the flow at the receiving manhole.
7. Formulation 1 was then dosed according to the above rate at Location 3a directly into the inlet water (via stainless steel down pipe) that ensured excellent mixing and instantaneous contact with incoming contaminants at the inlet to Location 3a.
8. After 4 hours of dosing from 10:30 am to 2:30 pm, 225 litres Formulation 1 was added to Location 3a, at ˜3,000 ppm (˜75 KL treated).
9. By 3pm, Location 3b and Location 3c had again been switched off and only the flow from Location 3a was on. One full pump cycle was allowed to discharge and following the same technique for sampling, H₂S, mercaptans, pH and alkalinity were once again recorded during the next pump cycle from Location 3a.
10. MHL was dosed continuously throughout the peracetic acid (Formulation 1) dosing trial.

Results:

Before and after Formulation 1 dosing results, tested at the receiving manhole (4.5 km downstream) are shown in the following Table 6 for the key metrics tested:

TABLE 6
Dosing Results for Key Metrics Trial 3

| Key Performance | Before | | 4 hrs After | | 3 weeks After | | 10 weeks After | |
|---|---|---|---|---|---|---|---|---|
| Indicator | Formulation 1 | | Formulation 1 | | Formulation 1 | | Formulation 1 | |
| pH | >8.4 | | >8.4 | | >8.4 | | >8.4 | |
| Alkalinity | ~200 | mg/L | ~200 | mg/L | ~240 | mg/L | ~180 | mg/L |
| Mercaptan | 2 | ppm | Not Detected | | Not Detected | | Not Detected | |
| Instantaneous H₂S | <5 | ppm | <0.5 | ppm | <0.5 | ppm | <0.5 | ppm |

The results clearly show that Formulation 1 reduced the mercaptan levels from 2 ppm to below the level of detection. Note that the odour threshold for methyl mercaptan (the most likely mercaptan found) is 2 ppb, which means the detected level prior to commencing the trial was 1,000 times higher than the level we can detect with our sense of smell.

During both the initial and final evaluations at the receiving manhole, the installed Odalog recorded instantaneous H₂S values of 50-100 ppm of H₂S during the pump out of Location 3c in particular. When both Location 3b and Location 3c were switched off, H₂S recordings from Location 3a alone were shown to be significantly lower at a maximum of 5 ppm initially and barely registered after the Formulation 1 dosing.

Importantly, whilst the initial oxidation of free H₂S and mercaptans were proven during this trial (See results at 4 hrs after Formulation 1), the (lack of) recovery of these sewerage systems by-products was a key feature and understanding in the following weeks (See results, Table 6, at 3 weeks after Formulation 1 treatment).

pH control during the trial further demonstrated the continued performance of MHL dosing such that the pH above 8.4 was recorded in Location 3a flows after the 4.5 km journey. Likewise, there was no appreciable difference in alkalinity before and after the Formulation 1 dosing and allows for continued excellent H₂S and corrosion control through to the waste water treatment plant (WWTP) Noted, that alkalinity coming through the WWTP has been higher since commencement of MHL dosing. With the expansion of MHL dosing throughout the network, further improvements in inlet alkalinity to support efficient de-nitrification, digestion and settling processes can be expected.

With the alkalinity increase noted after 3 weeks post Formulation 1 dosing, there was scope to reduce MHL dosing. At that time, the operations team decided to keep the alkalinity for the purpose of mixing with other non-treated streams but highlighted the idea that MHL dosing can be reduced after Formulation 1 dosing. Prior to the 10-week post-Formulation 1 trial testing, the MHL dose rate was reduced by 25%. The alkalinity was proportional to this reduction and importantly the H₂₅ and mercaptan levels did not change.

Conclusion

The ability to isolate rising mains and test specific inputs to the receiving manhole has enabled a conclusive outcome from this Formulation 1 trial. With the data recorded and results achieved, the following conclusions were determined:
1. The cause of the residual odour from Location 3a was indeed of mercaptan origin. This was confirmed not only with the mercaptan Drager tube results but also from four “experienced noses” that likewise noted and commented on the complete lack of odour coming from Location 3a alone immediately after treatment and again 10 weeks later, still no discernible odour.
2. H₂S readings from Location 3a were validated by stopping pump cycles from the other two rising mains coming from Location 3b and Location 3c. This proved unequivocally that residual H₂S is coming from the untreated lines and not from Location 3a. This further proved that MHL was in fact treating H₂S alone quite successfully and MHL products used alone does not sequester or impact mercaptans as expected.
3. PAA dosing into Location 3a demonstrated the immediate effect of eliminating mercaptan and whilst at the same time further eliminated residual H₂S.
4. H₂S and mercaptan levels did not return to pre-Formulation 1 trial results, even after 10 weeks. Ongoing monitoring will show just how long it takes for bacteria to re-grow and bring back mercaptan levels to a detectable level. Each successive Formulation 1 dose is expected to extend the time between kill dose regimes.

### CITATION LIST

Nangia, P., and Benson, s. w., “The Preparation of Diethyl Peroxide. The Use of Dispersing Agents to Increase Yields in Heterogeneous Systems”, J. Org. Chem. 1962, 27, 5, 1882.

K. G. Stein, “Catalase binds hydroperoxyethane rapidly but catalysis is very inefficient”, Nature, 136, 335 (1935)

Ullman;s Encyclopedia of Industrial Chemistry, Peroxy Compounds, Organic, Wiley, 2018.

Comprehensive handbook of chemical bond energies (Yu Ran Luo) CRC Press Taylor & Francis Group.

Leveneur, S., Salmi, T., Murzin, D. Y., Estel, L., Wärnå, J. and Musakka, N. (2008). Kinetic Study and Modeling of Peroxypropionic Acid Synthesis from Propionic Acid and Hydrogen Peroxide using Homogeneous Catalysts. Ind. Eng. Chem. Res., 47, 656 664.

^{a}Homer R. Williams and Harry S. Mosher, Peroxides. I. n-Alkyl Hydroperoxides, J. Am. Chem. Soc. 1954, 76, 11

^{b}Homer R. Williams and Harry S. Mosher, Organic Peroxides. II. Secondary Alkyl Hydroperoxides Journal of the American Chemical Society, 1954, 76, 11, 2987-2990

U.S. Pat. No. 4,087,454, Prescher, G., Weiberg, O., Waldmann, H. and Seifert, H. (1978). Process for the preparation of perpropionic acid solutions.

Sun J, Hu S, Sharma K R, Ni B-J, Yuan Z. 2014. Stratified microbial structure and activity in sulfide- and methane-producing anaerobic sewer biofilms. Appl Environ Microbiol 80:7042-7052).

Penghui Du, Wen Liu, Hongbin Cao, He Zhao, Ching-Hua Huang, Water Research X, Volume 1, 2018, 100002

Ken Anderson, Paul Sallis, Sinan Uyanik, Anaerobic treatment processes, Handbook of Water and Wastewater Microbiology, 2003, 391-426

Regulation (EU) No 528/2012 concerning the making available on the market and use of biocidal products.

1. A method for disrupting biofilm in wastewater systems comprising the step of adding to the system at least one biofilm disrupting dose of one or more compounds of general formula I:
R—O—O—R¹ I
wherein, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H, M⁺, C₁-C₈ alkyl, substituted C₁-C₈ alkyl, aryl, substituted aryl, C₁-C₈ acyl, substituted C₁-C₈ acyl, arylacyl and substituted arylacyl.

2. The method of claim 1 wherein the wastewater system is a sewerage network comprised of wet wells, rising mains, gravity mains, manholes and pump stations.

3. The method of claim 2 wherein the biofilm disrupting dose is added to a wet well.

4. The method of claim 3 wherein the biofilm disrupting dose is delivered into a rising main downstream of the wet well.

5. The method of claim 1 wherein R is selected from C₁-C₈ alkyl, substituted C₁-C₁ alkyl, aryl, substituted aryl, C₁-C₈ acyl, substituted C₁-C₈ acyl, arylacyl and substituted arylacyl; and R¹ is selected from H.

6. The method of claim 1 wherein the biofilm disrupting dose further comprises hydrogen peroxide and water.

7. The method of claim 4 wherein the delivery of the biofilm disrupting dose into a rising main comprises the steps of:
substantially emptying the wet well of wastewater contained therein;
adding to the wet well a quantity of recycled or fresh water of at least about 15% of the cycle volume of the wet well;
delivering the added quantity of recycled or fresh water into the rising main connected to the wet well to flush at least a portion of the rising main with the water;
adding to the wet well a further quantity of recycled or fresh water of at least about 15% of the cycle volume of the wet well;
adding to the wet well a biofilm disrupting dose of one or more compounds of general formula I into the wet well to generate a dose fluid in the wet well; and
delivering the dose fluid into a rising main.

8. The method of claim 7 further comprising the step of acidifying the dose fluid to a pH in the range of about pH 5 to about 7 prior to delivering the fluid to the rising main.

9. The method of claim 1 further comprising the step treating the wastewater system with a microbiostatic agent.

10. The method of claim 9 wherein the microbiostatic agent is selected from: Mg(OH)₂, NaOH, Ca(OH)₂, H₂O₂, KMnO₄, and salts of Fe^{II} and Fe^{III}.

11. The method of claim 1 further comprising the step of treating the wastewater system with an odour control agent.

12. The method of claim 11 wherein the odour control agent is selected from: Mg(OH)₂, NaOH, H₂O₂, salts of NO₃⁻ including Ca(NO₃)₂ and NaNO₃, salts of NO₂⁻, Ca(OH)₂, KMnO₄ and salts of Fe^{II} and Fe^{III}.

13. The method of claim 10 wherein, the microbiostatic agent is also an odour control agent.

14. The method of claim 10 wherein the microbiostatic agent is Mg(OH)₂.

15. The method of claim 3 wherein the dose concentration of the compound general formula I in the wet well is from about 1 mmol/L to about 60 mmol/L, preferably from about 2 mmol/L to about 20 mmol/L, and more preferably from about 4 mmol/L to about 10 mmol/L, with the amount of compound added to achieve the dose concentration based on the total wet well cycle volume.

16. The method of claim 15 wherein the at least one biofilm disrupting dose of one or more compounds of general formula I is peracetic acid within a formulation comprising peroxyacetic acid, acetic acid, hydrogen peroxide and water.

17. A biofilm disrupting formulation for use in the treatment of wastewater systems comprising two or more organic peroxy compounds of general formula I:
ROOR¹ I
wherein, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H, M⁺, C₁-C₈ alkyl, substituted C₁-C₈ alkyl, aryl, substituted aryl, C₁-C₈ acyl, substituted C₁-C₈ acyl, arylacyl and substituted arylacyl.

18. A method for treating biofilm in wastewater systems the method comprising the step of administering to the system a dosage of a formulation comprising a biofilm disrupting agent of general formula I:
R—O—O—R¹ I
wherein, R is selected from C₁-C₈ alkyl, substituted C₁-C₈ alkyl, aryl, substituted aryl, C₁-C₈ acyl, substituted C₁-C₈ acyl, arylacyl and substituted arylacyl; and R¹ is selected from H, C₁-C₈ alkyl, substituted C₁-C₈ alkyl, aryl, substituted aryl, C₁-C₈ acyl, substituted C₁-C₈ acyl, arylacyl and substituted arylacyl.

19. The method of claim 1 wherein a degradation product of the organic peroxy compound of general formula I is an organic compound which is naturally present in the wastewater system.

20. The method of claim 1 wherein at least one biofilm disrupting dose comprises two or more peroxy compounds of general formula I each of differing physico-chemical properties.
